(19) United States
(12) Patent Application Publication
(10) Pub. No.: US 2026/0231232 A1
(43) Pub. Date: Aug. 6, 2026

(54) REPETITIONS OF RANDOM ACCESS CHANNEL TRANSMISSIONS

(71) Applicant: QUALCOMM Incorporated, San Diego, CA (US)

(72) Inventors: Liangping MA, San Diego, CA (US); Xiao Feng WANG, San Diego, CA (US); Bharat SHRESTHA, San Diego, CA (US); Jae Ho RYU, San Diego, CA (US); Le LIU, San Jose, CA (US); Umesh PHUYAL, San Diego, CA (US); Changhwan PARK, San Diego, CA (US)

(21) Appl. No.: 19/465,394

(22) Filed: Jan. 30, 2026

Related U.S. Application Data
(60) Provisional application No. 63/753,818, filed on Feb. 4, 2025.

(51) Int. Cl. H04W 74/0833; H04L 1/00; H04W 74/00

(52) U.S. Cl. CPC H04W 74/0833; H04L 1/0009; H04W 74/006

(57) ABSTRACT

Various aspects of the present disclosure generally relate to wireless communication. In some aspects, a user equipment (UE) may receive, from a network node, signaling indicating that the network node supports UE-specific repetitions for a random access channel (RACH) transmission from the network node during a RACH procedure. The UE may receive, from the network node, downlink control information (DCI) scheduling the RACH transmission from the network node, wherein the DCI comprises an indication of a quantity of repetitions for the RACH transmission that is specific to the UE. The UE may perform a decode operation for the RACH transmission based at least in part on monitoring for the quantity of repetitions of the RACH transmission. Numerous other aspects are described.

### CROSS-REFERENCE TO RELATED APPLICATION

This Patent Application claims priority to U.S. Provisional Patent Application No. 63/753,818, filed on February 4, 2025, entitled “REPETITIONS OF RANDOM ACCESS CHANNEL TRANSMISSIONS,” and assigned to the assignee hereof. The disclosure of the prior Application is considered part of and is incorporated by reference into this Patent Application.

### FIELD OF THE DISCLOSURE

Aspects of the present disclosure generally relate to wireless communication and specifically relate to techniques, apparatuses, and methods associated with repetitions of random access channel (RACH) transmissions.

### DESCRIPTION OF THE RELATED TECHNOLOGY

Wireless communication systems are widely deployed to provide various services, which may involve carrying or supporting voice, text, other messaging, video, data, or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, or device transmit power, among other examples). Such multiple-access RATs are supported by technological advancements that have been adopted in various telecommunication standards, which define common protocols that enable different wireless communication devices to communicate on a local, municipal, national, regional, or global level. An example telecommunication standard is New Radio (NR). NR, which also may be referred to as 5G, is part of a continuous mobile broadband evolution promulgated by the Third Generation Partnership Project (3GPP). As the demand for connectivity continues to increase, further improvements in NR may be implemented, and other RATs, such as 6G and beyond, may be introduced to enable new applications and facilitate new use cases.

In some wireless communication networks, a wireless communication device may initiate a random access channel procedure to establish an initial connection between the wireless communication device and a network node, to re-establish a connection between the wireless communication device and the network node, to perform a handover procedure to the network node, to transition to an active radio resource control connection, or as part of a beam failure recovery procedure.

### SUMMARY

In some wireless communication networks, a user equipment (UE) may initiate a random access channel (RACH) procedure to establish an initial connection between the UE and a network node. The RACH procedure may include one or more transmissions from the UE to the network node and one or more transmissions from the network node to the UE. For example, in a two-step RACH procedure, the UE may transmit a first message (e.g., a msgA) to the network node, and the network node may transmit a second message (e.g., a msgB) to the UE. Additionally, in a four-step RACH procedure, the UE may transmit a first message (e.g., a msg1) and a second message (e.g., a msg3) to the network node, and the network node may transmit a second message (e.g., a msg2) and a fourth message (e.g., a msg4) to the UE. In some wireless communication networks, a channel condition between the UE and the network node may degrade a quality of one or more of the RACH transmissions between the UE and the network node, which may prevent either the UE or the network node from being able to successfully detect or decode the RACH transmissions. Additionally, the channel conditions between different UEs and the network node may be different.

In wireless communication networks described herein, a network node may be capable of transmitting more than one repetition of a RACH transmission to a UE, and the quantity of repetitions of the RACH transmission may be specific to the UE. For example, the network node may determine the quantity of repetitions of the RACH transmission based on a channel condition between the UE and the network node. In some cases, the network node may estimate the channel condition based on performing a measurement on a RACH transmission received from the UE. The network node may then indicate the quantity of the repetitions of the RACH transmission within downlink control information (DCI) that schedules the RACH transmission. For example, the network node may indicate a quantity of repetitions for a msgB RACH transmission within DCI that schedules the msgB RACH transmission. In another example, the network node may indicate a quantity of repetitions for a msg4 RACH transmission within DCI that schedules the msg4 RACH transmission. Accordingly, the network node may transmit a UE-specific quantity of repetitions of a RACH transmission, which may improve a reliability of the RACH transmission without adding an unnecessary amount of signaling overhead (e.g., by transmitting a large quantity of repetitions of a RACH transmission to a UE associated with a relatively good channel condition).

The UE may perform a decode operation based on monitoring for the UE-specific quantity of repetitions. As used herein, the UE performing the decode operation may include the UE attempting to decode the RACH transmission. For example, the UE may initiate a decode attempt of the RACH transmission. Based on monitoring the UE-specific quantity of repetitions, the UE may decode the RACH transmissions based on the UE detecting the UE-specific quantity of repetitions. In other words, the UE proceeds with decoding the RACH transmission if the UE-specific quantity of repetitions are detected by the UE.

The systems, methods, and devices of this disclosure each have several innovative aspects, no single one of which is solely responsible for the desirable attributes disclosed herein.

Some aspects described herein relate to a method of wireless communication performed by a UE. The method may include receiving, from a network node, signaling indicating that the network node supports UE-specific repetitions for a RACH transmission from the network node during a RACH procedure. The method may include receiving, from the network node, DCI scheduling the RACH transmission from the network node, wherein the DCI comprises an indication of a quantity of repetitions for the RACH transmission that is specific to the UE. The method may include performing a decode operation for the RACH transmission based at least in part on monitoring for the quantity of repetitions of the RACH transmission.

Some aspects described herein relate to a method of wireless communication performed by a UE. The method may include receiving, from a network node, signaling indicating that the network node supports UE-specific repetitions for a fourth message of a four-step RACH procedure. The method may include receiving, from the network node, DCI scheduling the fourth message, wherein the DCI comprises an indication of a quantity of repetitions for the fourth message that is specific to the UE. The method may include performing a decode operation for the fourth message of the four-step RACH procedure based at least in part on monitoring for the quantity of repetitions of the fourth message.

Some aspects described herein relate to a method of wireless communication performed by a UE. The method may include receiving, from a network node, signaling indicating that the network node supports UE-specific repetitions for a second message of a two-step RACH procedure. The method may include receiving, from the network node, DCI scheduling the second message, wherein the DCI comprises an indication of a quantity of repetitions for the second message that is specific to the UE. The method may include performing a decode operation for the second message of the two-step RACH procedure based at least in part on monitoring for the quantity of repetitions of the second message.

Some aspects described herein relate to a method of wireless communication performed by a network node. The method may include transmitting, to a UE, signaling indicating that the network node supports UE-specific repetitions for a RACH transmission from the network node during a RACH procedure. The method may include transmitting, to the UE, DCI scheduling the RACH transmission from the network node, wherein the DCI comprises an indication of a quantity of repetitions for the RACH transmission that is specific to the UE. The method may include transmitting the quantity of repetitions of the RACH transmission to the UE.

Some aspects described herein relate to a non-transitory computer-readable medium that stores a set of instructions for wireless communication by a UE. The set of instructions, when executed by one or more processors of the UE, may cause the UE to receive, from a network node, signaling indicating that the network node supports UE-specific repetitions for a RACH transmission from the network node during a RACH procedure. The set of instructions, when executed by one or more processors of the UE, may cause the UE to receive, from the network node, DCI scheduling the RACH transmission from the network node, wherein the DCI comprises an indication of a quantity of repetitions for the RACH transmission that is specific to the UE. The set of instructions, when executed by one or more processors of the UE, may cause the UE to perform a decode operation for the RACH transmission based at least in part on monitoring for the quantity of repetitions of the RACH transmission.

Some aspects described herein relate to a non-transitory computer-readable medium that stores a set of instructions for wireless communication by a UE. The set of instructions, when executed by one or more processors of the UE, may cause the UE to receive, from a network node, signaling indicating that the network node supports UE-specific repetitions for a fourth message of a four-step RACH procedure. The set of instructions, when executed by one or more processors of the UE, may cause the UE to receive, from the network node, DCI scheduling the fourth message, wherein the DCI comprises an indication of a quantity of repetitions for the fourth message that is specific to the UE. The set of instructions, when executed by one or more processors of the UE, may cause the UE to decode the fourth message of the four-step RACH procedure based at least in part on monitoring for the quantity of repetitions of the fourth message.

Some aspects described herein relate to a non-transitory computer-readable medium that stores a set of instructions for wireless communication by a UE. The set of instructions, when executed by one or more processors of the UE, may cause the UE to receive, from a network node, signaling indicating that the network node supports UE-specific repetitions for a second message of a two-step RACH procedure. The set of instructions, when executed by one or more processors of the UE, may cause the UE to receive, from the network node, DCI scheduling the second message, wherein the DCI comprises an indication of a quantity of repetitions for the second message that is specific to the UE. The set of instructions, when executed by one or more processors of the UE, may cause the UE to decode the second message of the two-step RACH procedure based at least in part on monitoring for the quantity of repetitions of the second message.

Some aspects described herein relate to a non-transitory computer-readable medium that stores a set of instructions for wireless communication by a network node. The set of instructions, when executed by one or more processors of the network node, may cause the network node to transmit, to a UE, signaling indicating that the network node supports UE-specific repetitions for a RACH transmission from the network node during a RACH procedure. The set of instructions, when executed by one or more processors of the network node, may cause the network node to transmit, to the UE, DCI scheduling the RACH transmission from the network node, wherein the DCI comprises an indication of a quantity of repetitions for the RACH transmission that is specific to the UE. The set of instructions, when executed by one or more processors of the network node, may cause the network node to transmit the quantity of repetitions of the RACH transmission to the UE.

Some aspects described herein relate to a UE. The UE may include a processing system. The processing system may include one or more processors and one or more code-storing memories coupled with the one or more processors. The processing system may be configured to cause the UE to receive, from a network node, signaling indicating that the network node supports UE-specific repetitions for a RACH transmission from the network node during a RACH procedure. The processing system may be configured to cause the UE to receive, from the network node, DCI scheduling the RACH transmission from the network node, wherein the DCI comprises an indication of a quantity of repetitions for the RACH transmission that is specific to the UE. The processing system may be configured to cause the UE to perform a decode operation for the RACH transmission based at least in part on monitoring for the quantity of repetitions of the RACH transmission.

Some aspects described herein relate to a UE. The UE may include a processing system. The processing system may include one or more processors and one or more code-storing memories coupled with the one or more processors. The processing system may be configured to cause the UE to receive, from a network node, signaling indicating that the network node supports UE-specific repetitions for a fourth message of a four-step RACH procedure. The processing system may be configured to cause the UE to receive, from the network node, DCI scheduling the fourth message, wherein the DCI comprises an indication of a quantity of repetitions for the fourth message that is specific to the UE. The processing system may be configured to cause the UE to perform a decode operation for the fourth message of the four-step RACH procedure based at least in part on monitoring for the quantity of repetitions of the fourth message.

Some aspects described herein relate to a UE. The UE may include a processing system. The processing system may include one or more processors and one or more code-storing memories coupled with the one or more processors. The processing system may be configured to cause the UE to receive, from a network node, signaling indicating that the network node supports UE-specific repetitions for a second message of a two-step RACH procedure. The processing system may be configured to cause the UE to receive, from the network node, DCI scheduling the second message, wherein the DCI comprises an indication of a quantity of repetitions for the second message that is specific to the UE. The processing system may be configured to cause the UE to perform a decode operation for the second message of the two-step RACH procedure based at least in part on monitoring for the quantity of repetitions of the second message.

Some aspects described herein relate to a network node. The network node may include a processing system. The processing system may include one or more processors and one or more code-storing memories coupled with the one or more processors. The processing system may be configured to cause the network node to transmit, to a UE, signaling indicating that the network node supports UE-specific repetitions for a RACH transmission from the network node during a RACH procedure. The processing system may be configured to cause the network node to transmit, to the UE, DCI scheduling the RACH transmission from the network node, wherein the DCI comprises an indication of a quantity of repetitions for the RACH transmission that is specific to the UE. The processing system may be configured to cause the network node to transmit the quantity of repetitions of the RACH transmission to the UE.

Some aspects described herein relate to an apparatus for wireless communication. The apparatus may include means for receiving, from a network node, signaling indicating that the network node supports apparatus-specific repetitions for a RACH transmission from the network node during a RACH procedure. The apparatus may include means for receiving, from the network node, DCI scheduling the RACH transmission from the network node, wherein the DCI comprises an indication of a quantity of repetitions for the RACH transmission that is specific to the apparatus. The apparatus may include means for performing a decode operation for the RACH transmission based at least in part on monitoring for the quantity of repetitions of the RACH transmission.

Some aspects described herein relate to an apparatus for wireless communication. The apparatus may include means for receiving, from a network node, signaling indicating that the network node supports UE-specific repetitions for a fourth message of a four-step RACH procedure. The apparatus may include means for receiving, from the network node, DCI scheduling the fourth message, wherein the DCI comprises an indication of a quantity of repetitions for the fourth message that is specific to the apparatus. The apparatus may include means for performing a decode operation for the fourth message of the four-step RACH procedure based at least in part on monitoring for the quantity of repetitions of the fourth message.

Some aspects described herein relate to an apparatus for wireless communication. The apparatus may include means for receiving, from a network node, signaling indicating that the network node supports UE-specific repetitions for a second message of a two-step RACH procedure. The apparatus may include means for receiving, from the network node, DCI scheduling the second message, wherein the DCI comprises an indication of a quantity of repetitions for the second message that is specific to the apparatus. The apparatus may include means for performing a decode operation for the second message of the two-step RACH procedure based at least in part on monitoring for the quantity of repetitions of the second message.

Some aspects described herein relate to an apparatus for wireless communication. The apparatus may include means for transmitting, to a UE, signaling indicating that the network node supports UE-specific repetitions for a RACH transmission from the network node during a RACH procedure. The apparatus may include means for transmitting, to the UE, DCI scheduling the RACH transmission from the network node, wherein the DCI comprises an indication of a quantity of repetitions for the RACH transmission that is specific to the UE. The apparatus may include means for transmitting the quantity of repetitions of the RACH transmission to the UE.

Aspects of the present disclosure may generally be implemented by or as a method, apparatus, system, computer program product, non-transitory computer-readable medium, user equipment, network node, wireless communication device, or processing system as substantially described in the Detailed Description with reference to, and as illustrated by, the accompanying drawings. Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only some aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless communication network.

FIG. 2 is a diagram illustrating an example disaggregated network node architecture.

FIG. 3 is a diagram illustrating an example of a wireless communication network.

FIG. 4 is a diagram illustrating an example of a four-step random access procedure.

FIG. 5 is a diagram illustrating an example of a two-step random access procedure.

FIGS. 6-8 are diagrams illustrating example processes performed, for example, at a user equipment (UE) or an apparatus of a UE.

FIG. 9 is a diagram illustrating an example process performed, for example, at a network node or an apparatus of a network node.

FIGS. 10 and 11 are diagrams of example apparatuses for wireless communication.

### DETAILED DESCRIPTION

A user equipment (UE) may initiate a random access channel (RACH) procedure to establish an initial connection between the wireless communication device and a network node, to re-establish a connection between the wireless communication device and the network node, to perform a handover procedure to the network node, to transition to an active radio resource control (RRC) connection, or as part of a beam failure recovery procedure. The RACH procedure may include one or more transmissions from the UE to the network node and one or more transmissions from the network node to the UE. For example, in a two-step RACH procedure, the UE may transmit a first message (e.g., a msgA) to the network node, and the network node may transmit a second message (e.g., a msgB) to the UE. Additionally, in a four-step RACH procedure, the UE may transmit a first message (e.g., a msg1) and a second message (e.g., a msg3) to the network node, the network node may transmit a second message (e.g., a msg2) and a fourth message (e.g., a msg4) to the UE.

In some wireless communication networks, a channel condition between the UE and the network node may degrade a quality of one or more of the RACH transmissions between the UE and network node, which may prevent either the UE or the network node from being able to successfully detect or decode the RACH transmissions. For example, in non-terrestrial network (NTN) deployments, a power flux density (PFD) may be limited by a regulation, which may limit a signal strength of transmissions from the network node to the UE. Additionally, in the NTN deployments, the network node (e.g., corresponding to a satellite) may not have sufficient transmission power for one or more RACH transmissions, as the network node may be sharing power among many beams.

Additionally, the channel conditions between different UEs and the network node may be different. Accordingly, configuring a RACH transmission to be associated with a quantity of repetitions that is the same for each UE in a group of UEs may not adequately account for the varying channel conditions between each of the different UEs in the group and the network node. For example, the quantity of repetitions may be too large for UEs associated with relatively good channel conditions (e.g., which may add unnecessary signaling overhead) and may be too small for UEs associated with relatively poor channel conditions (e.g., which may not adequately improve a reliability of the RACH transmission).

Various aspects relate generally to introducing repetitions of a RACH transmission. Some aspects more specifically relate to a network node that is capable of transmitting more than one repetition of a RACH transmission to a UE, where the quantity of repetitions of the RACH transmission is specific to the UE. For example, the network node may determine the quantity of repetitions of the RACH transmission based on a channel condition between the UE and the network node. In some cases, the network node may estimate the channel condition based on performing a measurement on a RACH transmission received from the UE. The network node may then indicate the quantity of the repetitions of the RACH transmission within downlink control information (DCI) that schedules the RACH transmission. For example, the network node may indicate a quantity of repetitions for a msgB RACH transmission within DCI that schedules the msgB RACH transmission. In another example, the network node may indicate a quantity of repetitions for a msg4 RACH transmission within DCI that schedules the msg4 RACH transmission. Accordingly, the network node may transmit a UE-specific quantity of repetitions of a RACH transmission that is based on the channel condition between the UE and the network entity.

Particular aspects of the subject matter described in this disclosure can be implemented to realize one or more of the following potential advantages. In some examples, the described techniques can be used to improve a reliability of the RACH transmission without adding an unnecessary amount of signaling overhead. That is, by determining the quantity of repetitions based on the channel condition between the network node and the UE (e.g., by determining a UE-specific quantity of repetitions), the network node may avoid transmitting a large quantity of repetitions of a RACH transmission to a UE if the channel condition between the UE and the network node is relatively good. Additionally, the network node may indicate the quantity of UE-specific repetitions for the RACH transmission by repurposing a field in the DCI, and without adding additional bits to the DCI. Accordingly, the signaling overhead associated with the DCI may not be increased.

5G New Radio (NR) may support enhanced mobile broadband (eMBB) access, Internet of Things (IoT) networks or reduced capability (RedCap) device deployments, ultra-reliable low-latency communication (URLLC) applications, or massive machine-type communication (mMTC), among other examples. To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, NTN deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial or aerial platforms, among other examples.

The methods, operations, apparatuses, and techniques described herein may enable one or more of the foregoing technologies or new technologies or support one or more of the foregoing use cases or new use cases.

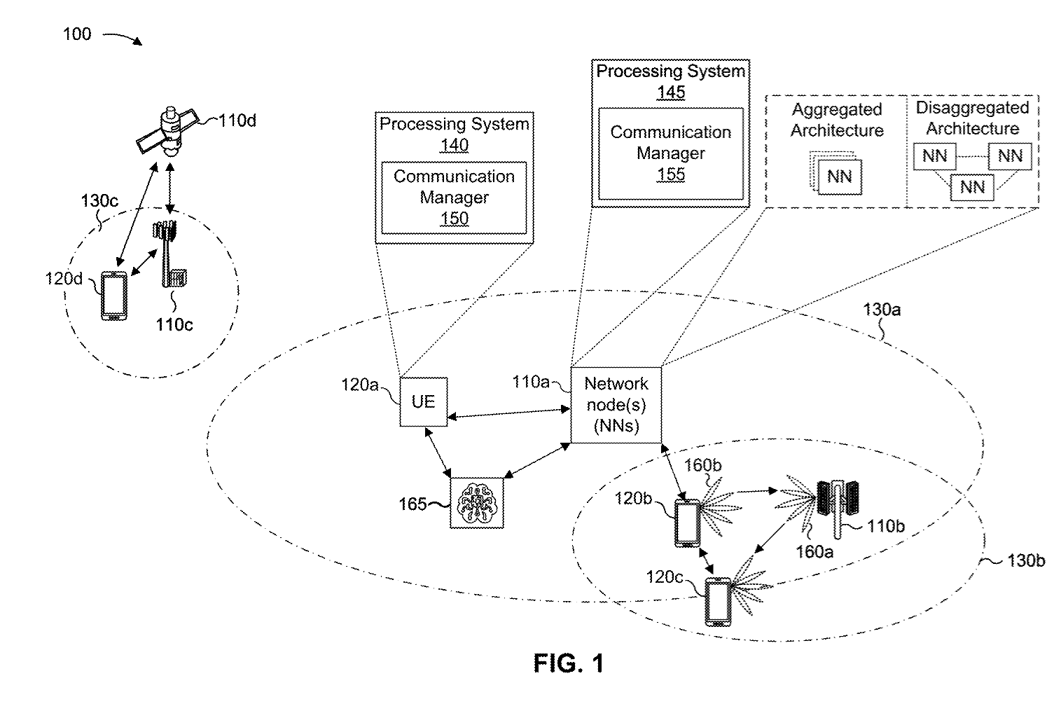

FIG. 1 is a diagram illustrating an example of a wireless communication network 100. The wireless communication network 100 may be or may include elements of a 5G network or a 6G network, among other examples. The wireless communication network 100 may include multiple network nodes 110. For example, in FIG. 1, the wireless communication network 100 includes multiple network nodes 110, including a network node 110a, a network node 110b, a network node 110c, and a network node 110d (each of which also may be referred to herein simply as a “network node 110”). The network nodes 110 may support communications with multiple UEs 120. For example, in FIG. 1, the network nodes 110 support communication with a UE 120a, a UE 120b, a UE 120c, and a UE 120d (each of which also may be referred to herein simply as a “UE 120”). In some examples, a UE 120 also may communicate with other UEs 120 and a network node 110 also may communicate with a core network and with other network nodes 110.

The network nodes 110 and the UEs 120 of the wireless communication network 100 communicate using the electromagnetic spectrum, which may be subdivided into various licensed or unlicensed operating bands, frequency ranges, component carriers, or channels that define associated frequencies available for communications. In some examples, each of the network nodes 110 and the UEs 120 may communicate using one or multiple component carriers in one or more operating bands or ranges. Typically, various operating bands are defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles.

A network node 110 or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system. As shown in FIG. 1, each UE 120 includes a processing system 140 and each network node 110 includes a processing system 145. A processing system (for example, the processing system 140 or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media, such as random-access memory, or read-only memory, or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors. One or more of the memories may individually or collectively store processor-executable code or instructions (such as software) (for example, which may referred to as “one or more code-storing memories” or “code-storing memory circuitry”). For example, “code-storing memory” or “code-storing memory circuitry” refers to memory (or memory circuitry) that is configured to store processor-executable code or instructions. The processor-executable code or instructions, when executed by one or more of the processors, may configure one or more of the processors (or processing circuitry) to perform various functions or operations described herein. Additionally, or alternatively, in some examples, one or more of the processors may be configured to perform various functions or operations described herein without requiring configuration by software. Software shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 or the processing system 145 may include or implement one or more of the modems. The processing system 140 and the processing system 145 also may include or be coupled with multiple radios (collectively “the radio”), multiple RF chains, or multiple transceivers, each of which may in turn be coupled with one or more of multiple antennas. In some examples, one or more processors of the processing system 140 or the processing system 145 may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by the processing system 140 or by the processing system 145).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device, such as the network node 110 and the UE 120.

A network node 110 may be, may include, or also may be referred to as an NR network node, a 5G network node, a 6G network node, a Node B, a gNB, an access point (AP), a transmission reception point (TRP), a network entity, a network element, a network equipment, or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may include a single standalone base station or a single TRP that operates with a full radio protocol stack to enable or facilitate communication between a UE 120 and a core network of the wireless communication network 100.

Alternatively, and as also shown, a network node 110 may be a disaggregated network node 110 (sometimes referred to as a disaggregated base station), having a disaggregated architecture, meaning that the network node 110 may operate with a radio protocol stack that is physically distributed or logically distributed among two or more nodes in the same geographic location or in different geographic locations. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The disaggregated network nodes 110 of the wireless communication network 100 may include one or more central units (CUs), one or more distributed units (DUs), and one or more radio units (RUs). A CU may host one or more higher layers, such as an RRC layer, a packet data convergence protocol (PDCP) layer, and a service data adaptation protocol (SDAP) layer, among other examples. A DU may host one or more of a radio link control (RLC) layer, a medium access control (MAC) layer, or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, or physical RACH (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, or one or more RUs. In some examples, a CU, a DU, or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

In some examples, the wireless communication network 100 may be a heterogeneous network that includes network nodes 110 of various types. Different types of network nodes 110 may generally operate on the same or different operating bands, transmit at different power levels, or serve different coverage areas, each of which may be referred to as or associated with a particular cell 130 (for example, a cell 130a, a cell 130b, and a cell 130c).

The UEs 120 may be physically dispersed throughout the coverage area of the wireless communication network 100, and each UE 120 may be stationary or mobile. A UE 120 may be, may include, or also may be referred to as an access terminal, a mobile station, a client device, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), an artificially intelligent robot or other device implementing artificial intelligence, a UE function of a network node, or any other suitable device or function that may communicate in the wireless communication network 100.

Some UEs 120 may be classified according to different categories in association with different complexities or different capabilities. UEs 120 in a first category may be associated with relatively low complexity or cost such as NB-IoT devices or eMTC UEs. UEs 120 in a second category may include higher complexity or cost devices, such as mission-critical IoT devices, baseline UEs, high-tier UEs, advanced UEs, full-capability UEs, or premium UEs that are capable of URLLC, eMBB, or precise positioning in the wireless communication network 100. A third category of UEs 120 may have mid-tier complexity or capabilities (for example, capabilities between that of the UEs 120 of the first category and the UEs 120 of the second category). A UE 120 of the third category may be referred to as a reduced capability UE (“RedCap UE”), a mid-tier UE, an NR-Light UE, or an NR-Lite UE, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a DCI configuration to the one or more UEs 120) or reconfigured (for example, in real-time or near-real-time) according to changing network conditions in the wireless communication network 100 or specific requirements of one or more UEs 120. An active BWP defines the operating bandwidth of the UE 120 within the operating bandwidth of the serving cell.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), or measurement information (for example, a layer 1 (L1)- reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120 or may transmit, to the UE 120, an indication of an MCS to be applied for an uplink signal.

A network node 110 or a UE 120 (such as by using the processing system 145 or the processing system 140, respectively, or one or more coupled modems) may perform signal processing on the information (such as filtering, amplification, modulation, digital-to-analog conversion, an IFFT operation, multiplexing, interleaving, mapping, or encoding, among other examples) to generate a processed signal in accordance with the selected MCS. In some examples, the network node 110 or the UE 120 (for example, using the processing system 145 or the processing system 140, respectively, or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 or one or more modems) may further perform spatial processing (for example, precoding) on the encoded information to generate one or more processed or precoded signals for downlink or uplink transmission, respectively. In some examples, the network node 110a or the UE 120a may perform codebook-based precoding or non-codebook-based precoding. Codebook-based precoding may involve selecting a precoder (for example, a precoding matrix) using a codebook. For example, the network node 110a may provide precoding information indicating which precoder, defined by the codebook, is to be used by the UE 120a. Non-codebook-based precoding may involve selecting or deriving a precoder based on, or otherwise associated with, one or more downlink or uplink signal measurements. The network node 110a or the UE 120a may transmit the processed downlink or uplink signals, respectively, via one or more antennas.

The network node 110a or the UE 120a may receive uplink signals or downlink signals, respectively, via one or more antennas. The network node 110a or the UE 120a (for example, using the processing system 145 or the processing system 140, respectively, or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, or decoding, among other examples), to map the received signal(s) to a sequence of binary bits (for example, received information) that estimates the information transmitted by the network node 110 or the UE 120 via the downlink or uplink signals. The network node 110a or the UE 120a (for example, using the processing system 145 or the processing system 140, respectively, or a coupled decoder or one or more modems) may decode the received information (such as by using an ECC, a decoding operation, or an FEC operation) to detect errors or correct bit errors in the received information to generate decoded information. The decoded information may estimate the information transmitted via the downlink or uplink signals.

In some examples, a UE 120 and a network node 110 may perform MIMO communication. MIMO communication generally refers to transmitting or receiving multiple signals (such as multiple layers or multiple data streams) simultaneously over the same time and frequency resources. A network node 110 or a UE 120 may communicate using single-user MIMO or multi-user MIMO (MU-MIMO), the latter of which being used by a network node 110 to simultaneously transmit signals to multiple UEs 120. MIMO techniques may involve spatial multiplexing (multi-layer transmission) or beamforming. To implement beamforming, the amplitudes or phases of signals transmitted via antenna elements may be modulated and shifted relative to each other (such as by manipulating a phase shift, a phase offset, or an amplitude) to generate one or more beams. For example, a network node 110 may generate one or more beams 160a, and a UE 120 may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with such a directional transmission or directional reception, a set of directional resources associated with a signal transmission or signal reception (for example, an angle of arrival, a horizontal direction, or a vertical direction), or a set of parameters or resources associated with one or more aspects of a directional signal, among other examples.

In some examples, a network node 110 or a UE 120 may implement massive MIMO, which may be associated with an increased (for example, “massive”) quantity of antennas at the network node 110 or at the UE 120, such as in a network implementing mmWave technology, which enables more precise beamforming or reduced interference. In some examples, the wireless communication network 100 may implement multi-TRP (mTRP) operation (including redundant transmission or reception on multiple TRPs) or non-coherent joint transmission (NC-JT).

The network node 110 and the UE 120 may establish a communication link or beam pair, and otherwise increase reliability, throughput, signal strength, or other signal properties for MIMO communications, by performing beam management operations, such as an initial beam acquisition operation, a beam refinement operation, or a beam recovery operation. For example, an initial beam acquisition operation may involve the network node 110 transmitting signals (for example, synchronization signal blocks (SSBs) or other signals) via respective beams (for example, of the beams 160 of the network node 110) and the UE 120 receiving and measuring the signal(s) via respective beams of multiple beams (for example, from the beams 160 of the UE 120) to identify a best beam (or beam pair) for communication between the UE 120 and the network node 110. A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified or defined via one or more spatial parameters, such as a transmission configuration indicator (TCI) state or a quasi-co-location (QCL) parameter, among other examples.

Some aspects and techniques as described herein may be implemented, at least in part, using an artificial intelligence (AI) program (for example, referred to herein as an “AI/ML model”), such as a program that includes a machine learning (ML) model or an artificial neural network (ANN) model. The AI/ML model may be deployed at one or more devices 165 (for example, one or more network nodes 110, one or more UEs 120, one or more servers, or one or more components of a cloud computing network, among other examples). For example, in a deployment in which AI/ML functionality is performed independently at a device 165, sometimes referred to as “overlay AI/ML,” the AI/ML model (or an instance or portion of the AI/ML model) may be deployed at a UE 120 (for example, by the processing system 140), a network node 110 (for example, by the processing system 145), one or more servers, or one or more components of a cloud computing network, among other examples. Additionally, or alternatively, in a deployment where AI/ML functionality is coordinated between different devices 165, sometimes referred to as “coordinated AI/ML,” or performed at all device and network layers, sometimes referred to as “native AI/ML,” the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, or efficient use of network bandwidth, or to reduce latency, among other examples). For example, the AI/ML model(s) may be trained to identify patterns or relationships in data corresponding to the wireless communication network 100, a device, or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases, such as a self-organizing network (SON), minimization of drive test (MDT), quality of experience (QoE), positioning, sensing, predictive mobility, or traffic prediction, among other examples. In some examples, AI-as-a-Service use cases may include measurement collection reporting by a UE 120, device selection criteria (for example, according to a geographical area where measurements are to be collected or UE capabilities to be used to collected measurements), or reporting configurations (for example, reporting parameters such as location, time, or sensor information, among other examples). Additionally, or alternatively, the AI/ML model(s) may enable AI/ML procedures (for example, RAN-triggered service establishment, configuration, inferencing using UE-side or network-side models, performance monitoring or management, or capability signaling, among other examples). Additionally, or alternatively, the AI/ML model(s) may enable RAN-based AI/ML services via one or more application program interfaces (APIs) or management interfaces for use cases, such as beam management, radio resource monitoring (RRM) relaxation, mobility prediction, load prediction, network energy savings, or coverage and capacity improvements, among other examples).

As indicated above, a network node 110 may be a terrestrial network node 110 (for example, a terrestrial base station or entity of a disaggregated base station) or an NTN network node 110. In the example shown in FIG. 1, the network node 110d may be an NTN node (for example, a network node 110 configured to operate in an NTN) and the cell 130c may be an NTN cell. For example, the wireless communication network 100 may include one or more NTN deployments including an NTN node or a relay station. In some examples, a relay station in an NTN deployment may be referred to as a “non-terrestrial relay station.” An NTN may facilitate access to the wireless communication network 100 for remote areas that may not otherwise be within a coverage area of a terrestrial network node 110, such as over water or remote areas in which a terrestrial network is not deployed. An NTN may provide connectivity for various applications, including satellite communications, IoT, MTC, or other applications. An NTN node may include a satellite, a manned aircraft system, or an unmanned aircraft system (UAS) platform, among other examples. A satellite may include a low-earth orbit (LEO) satellite, a medium-earth orbit (MEO) satellite, a geostationary earth orbit (GEO) satellite, or a high elliptical orbit (HEO) satellite, among other examples. A manned aircraft system may include an airplane, a helicopter, or a dirigible, among other examples. A UAS platform may include a high-altitude platform station (HAPS), a balloon, a dirigible, or an airplane, among other examples.

An NTN node may communicate directly or indirectly with other entities in the wireless communication network 100 using NTN communication. The other entities may include UEs 120 (for example, the UE 120d), other NTN network nodes 110 in the one or more NTN deployments, other types of network nodes 110 (for example, stationary, terrestrial, or ground-based network nodes, such as the network node 110c), relay stations, or one or more components or devices included in or coupled with a core network of the wireless communication network 100. For example, an NTN node may communicate with a UE 120 via a service link (for example, where the service link includes an access link). Additionally or alternatively, an NTN node may communicate with a network node 110c (for example, gateway or a terrestrial node providing connectivity for the NTN node to a data network or a core network) via a feeder link (for example, where the feeder link is associated with an N2 or an N3 interface). Additionally or alternatively, NTN nodes may communicate directly with one another via an inter-satellite link (ISL). In some examples, an NTN deployment may be transparent (for example, where the NTN node operates in a similar manner as a repeater or relay or where an access link does not terminate at the NTN node ). In some other examples, an NTN deployment may be regenerative. For example, an access link may terminate at the NTN node, and the NTN node may regenerate a signal (such as by performing signal processing or enhancement, which may include error correction, modulation or demodulation, or amplification).

In some examples, NTNs may support advanced technologies or capabilities, such as global narrowband Internet of things (IoT) or massive machine type communication (mMTC) coverage (for example, NTNs may provide continuous coverage for narrowband IoT devices or mMTC devices to transfer data to a central entity), enhanced tracking (for example, NTNs may enable improved tracking for a moving platform (for example, a ship, a train, a plane, or a truck) carrying specific items to be tracked), emergency or disaster management, ultra mobile broadband (ultra-mBB) (for example, NTNs may enable a UE 120 to receive or transmit large amounts of data with improve quality of experience over a wider geographic area), immersive communications (for example, NTNs may support holographic communications, or extended reality (XR) communications, among other examples, to enable fully immersive user experiences), ultra-massive communications (for example, NTNs may enable tracking, monitoring, control, or environment sensing for IoT devices or mMTC devices, enabling applications, such as smart cities, smart agriculture, smart transportation, or smart logistics) ultra-critical communications (for example, NTNs may support services with increased requirements for latency, availability, or reliability. This enables applications, such as tactile or haptic Internet, remote surgery, or remote industrial management) network sensing (for example, NTNs may support RF sensing or an integrated sensing and communication (ISAC) service), or integrated artificial intelligence (AI) (for example, NTNs may support distributed or integrated AI applications), among other examples. In some examples, NTNs may provide connectivity for one or more verticals, such as aeronautical platforms, maritime platforms, railways, automotive platforms, rural areas, government platforms, or emergency services, among other examples.

An NTN may provide direct connectivity to the wireless communication network 100 for one or more UEs 120, such as the UE 120d. In some examples, a UE 120 may be configured to access the wireless communication network 100 via a terrestrial network (for example, the cell 130a) or an NTN (for example, the cell 130c) using common hardware or software (for example, using common radios or antennas). NTNs may provide ubiquitous connectivity for UEs 120 through compatibility with terrestrial networks (for example, NTNs and terrestrial networks may use compatible waveforms (for example, waveforms supported by both an NTN and a terrestrial network) for seamless handovers between NTNs and terrestrial networks, or UEs may use common hardware or software for communicating via NTNs and terrestrial networks), spectrum sharing (for example, a flexible waveform design may enable spectrum sharing between NTNs and terrestrial networks), robustness to co-channel interference, network-based positioning (for example, dedicated pilot signals or reference signals may be used to facilitate accurate timing and phase measurements for accurate positioning), support of UEs without location resolution data (for example, for UEs without access to a global navigation satellite system (GNSS)), or support of TDD and FDD systems, among other examples.

In some wireless communication networks 100, a channel condition between a UE 120 and a network node 110 may degrade a quality of one or more of the RACH transmissions between the UE 120 and network node 110, which may prevent either the UE 120 or the network node 110 from being able to successfully detect or decode the RACH transmissions. For example, in NTN deployments, a PFD may be limited (e.g., by a regulation), which may in turn limit a signal strength of transmissions from the network node 110d to the UE 120c. Additionally, in the NTN deployments, the network node 110d may not have sufficient transmission power for one or more RACH transmissions, as the network node 110d may be sharing power among many beams.

Additionally, the channel conditions between different UEs 120 and the network node 110 may be different. Accordingly, configuring a RACH transmission to be associated with a quantity of repetitions that is the same for a group of UEs may not adequately account for the varying channel conditions between each of the different UEs 120 in the group and the network node 110. In the wireless communication network 100, a network node 110 may be capable of transmitting more than one repetition of a RACH transmission to a UE 120, and the quantity of repetitions of the RACH transmission is specific to the UE 120. For example, the network node 110 may determine the quantity of repetitions of the RACH transmission based on a channel condition between the UE 120 and the network node 110. The network node 110 may then indicate the quantity of the repetitions of the RACH transmission within DCI that schedules the RACH transmission. Accordingly, the network node 110 may transmit a UE-specific quantity of repetitions of a RACH transmission that is based on the channel condition between the UE 120 and the network node 110.

In some aspects, the UE 120 may include a communication manager 150. As described in more detail elsewhere herein, the communication manager 150 may receive, from a network node, signaling indicating that the network node supports UE-specific repetitions for a RACH transmission from the network node during a RACH procedure; receive, from the network node, DCI scheduling the RACH transmission from the network node, wherein the DCI comprises an indication of a quantity of repetitions for the RACH transmission that is specific to the UE; and perform a decode operation for the RACH transmission based at least in part on monitoring for the quantity of repetitions of the RACH transmission.

Additionally, or alternatively, the communication manager 150 may receive, from a network node, signaling indicating that the network node supports UE-specific repetitions for a fourth message of a four-step RACH procedure; receive, from the network node, DCI scheduling the fourth message, wherein the DCI comprises an indication of a quantity of repetitions for the fourth message that is specific to the UE; and perform a decode operation for the fourth message of the four-step RACH procedure based at least in part on monitoring for the quantity of repetitions of the fourth message.

Additionally, or alternatively, the communication manager 150 may receive, from a network node, signaling indicating that the network node supports UE-specific repetitions for a second message of a two-step RACH procedure; receive, from the network node, DCI scheduling the second message, wherein the DCI comprises an indication of a quantity of repetitions for the second message that is specific to the UE; and perform a decode operation for the second message of the two-step RACH procedure based at least in part on monitoring for the quantity of repetitions of the second message.

Additionally, or alternatively, the communication manager 150 may perform one or more other operations described herein.

In some aspects, the network node 110 may include a communication manager 155. As described in more detail elsewhere herein, the communication manager 155 may transmit, to a UE, signaling indicating that the network node supports UE-specific repetitions for a RACH transmission from the network node during a RACH procedure; transmit, to the UE, DCI scheduling the RACH transmission from the network node, wherein the DCI comprises an indication of a quantity of repetitions for the RACH transmission that is specific to the UE; and transmit the quantity of repetitions of the RACH transmission to the UE. Additionally, or alternatively, the communication manager 155 may perform one or more other operations described herein.

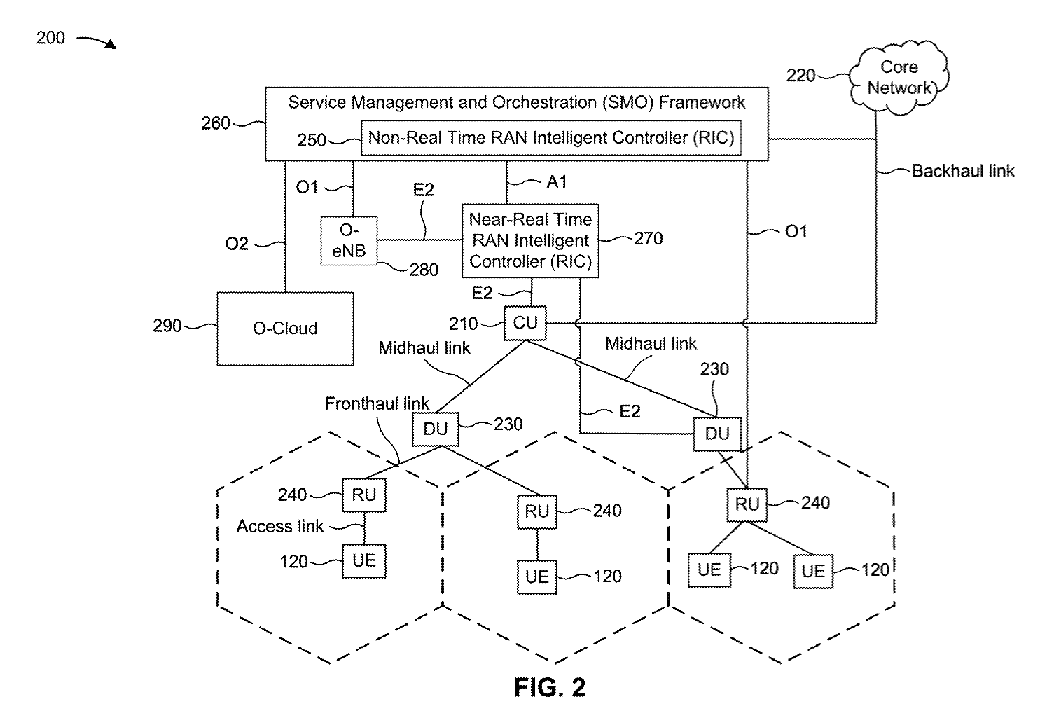

FIG. 2 is a diagram illustrating an example disaggregated network node architecture 200. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 or a near-real-time (Near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUs 210, the DUs 230, the RUs 240, the Near-RT RICs 270, the Non-RT RICs 250, and the SMO Framework 260, may include one or more interfaces or may be coupled with one or more interfaces for transmitting or receiving signals, such as data, control information, or reference signals via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, or a Near-RT RIC 270. In some aspects, the SMO Framework 260 may communicate with a hardware aspect of a 4G RAN, a 5G NR RAN, or a 6G RAN, such as an open eNB (O-eNB) 280, via an O1 interface. Additionally, or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, or policy-based guidance of applications or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, or an O-eNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

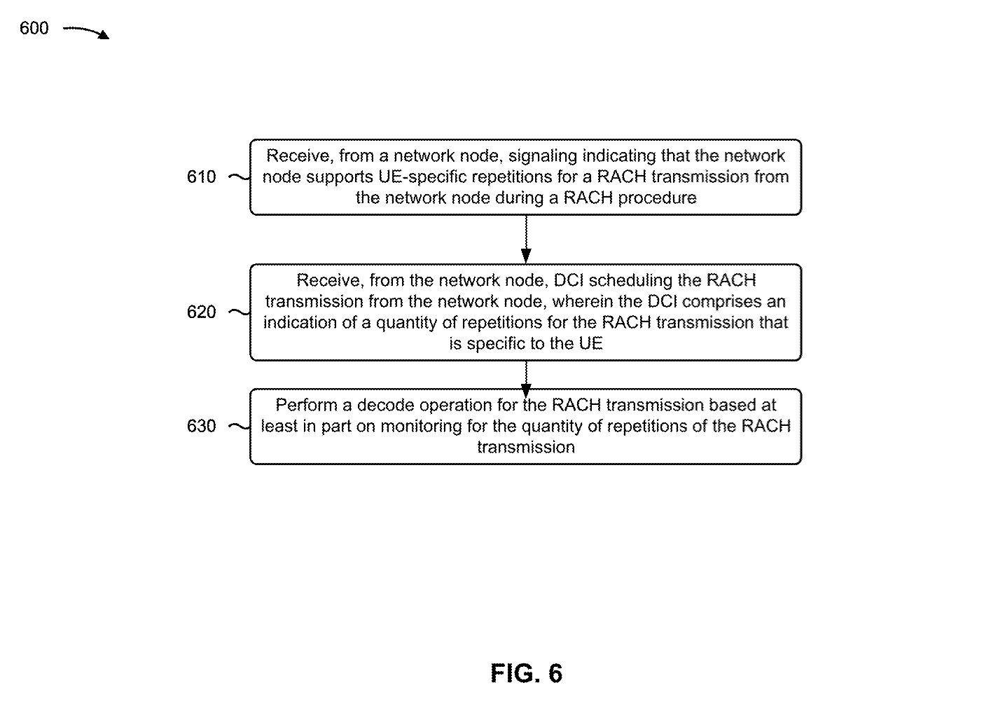

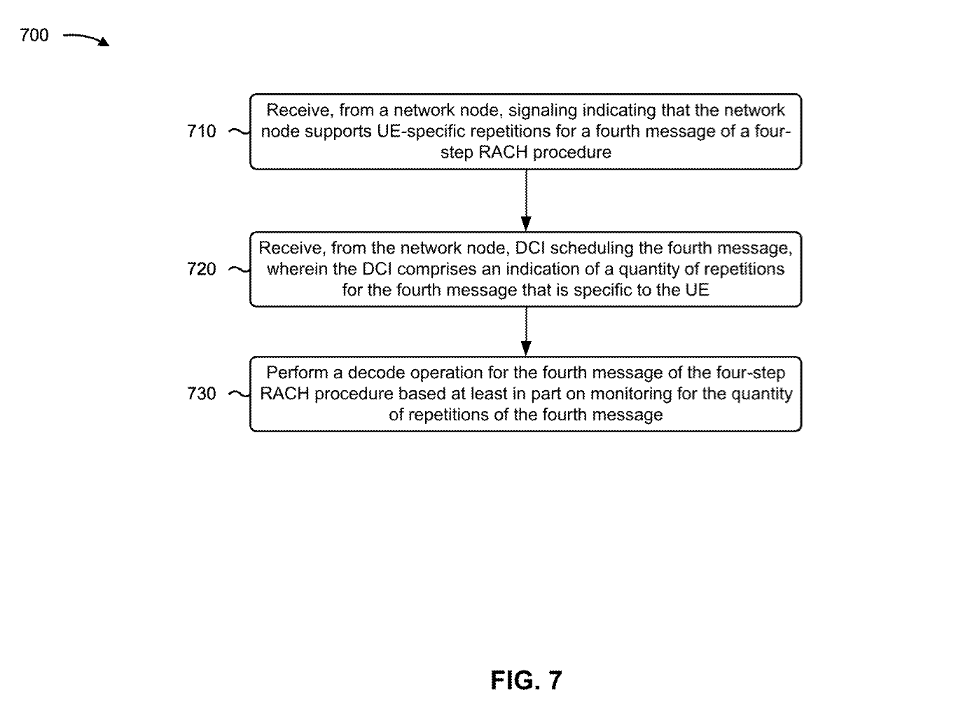

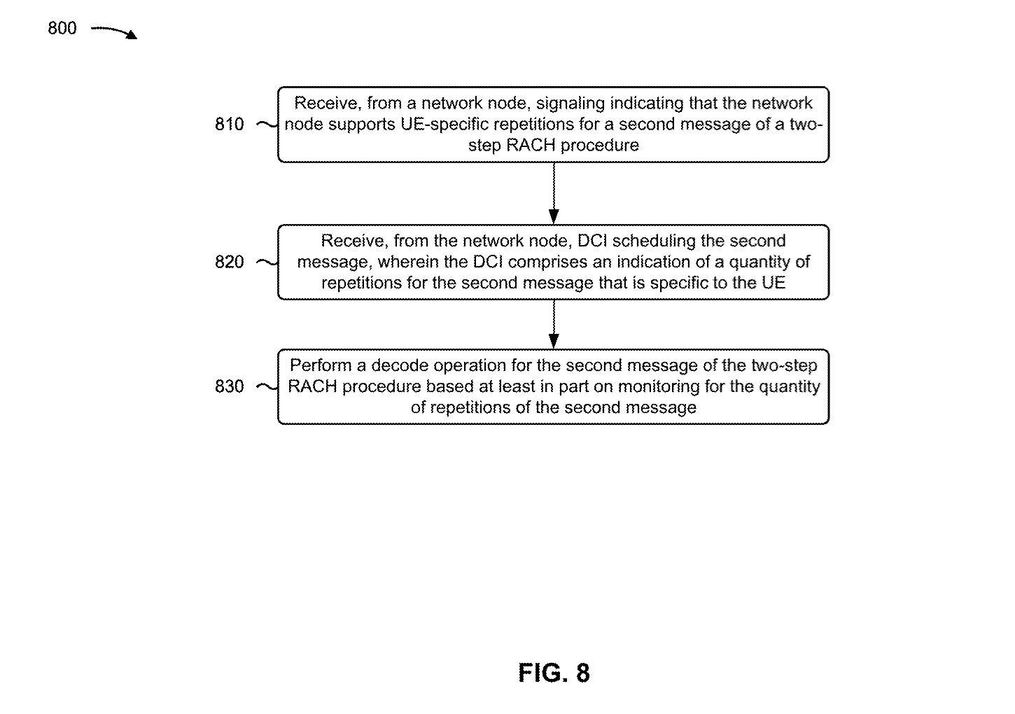

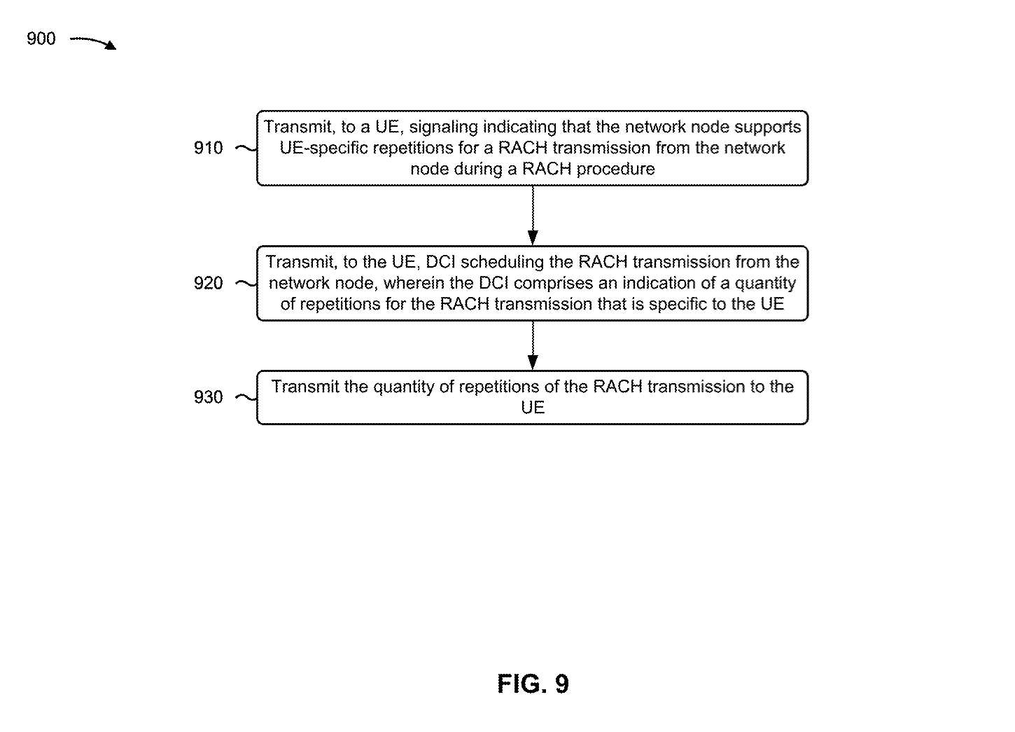

The network node 110, the processing system 145 of the network node 110, the UE 120, the processing system 140 of the UE 120, the CU 210, the DU 230, the RU 240, or any other component(s) of FIG. 1 or FIG. 2 may implement one or more techniques or perform one or more operations associated with repetitions of RACH transmissions, as described in more detail elsewhere herein. For example, the processing system 145 of the network node 110, the processing system 140 of the UE 120, the CU 210, the DU 230, or the RU 240 may perform or direct operations of, for example, process 600 of FIG. 6, process 700 of FIG. 7, process 800 of FIG. 8, process 900 of FIG. 9, or other processes as described herein (alone or in conjunction with one or more other processors). Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, the UE 120, the CU 210, the DU 230, or the RU 240, may cause the one or more processors to perform process 600 of FIG. 6, process 700 of FIG. 7, process 800 of FIG. 8, process 900 of FIG. 9, or other processes as described herein. In some examples, executing instructions may include running the instructions, converting the instructions, compiling the instructions, or interpreting the instructions, among other examples.

In some aspects, a UE includes means for receiving, from a network node, signaling indicating that the network node supports UE-specific repetitions for a RACH transmission from the network node during a RACH procedure; means for receiving, from the network node, DCI scheduling the RACH transmission from the network node, wherein the DCI comprises an indication of a quantity of repetitions for the RACH transmission that is specific to the UE; or means for performing a decode operation for the RACH transmission based at least in part on monitoring for the quantity of repetitions of the RACH transmission. Alternatively, the UE includes means for receiving, from a network node, signaling indicating that the network node supports UE-specific repetitions for a fourth message of a four-step RACH procedure; means for receiving, from the network node, DCI scheduling the fourth message, wherein the DCI comprises an indication of a quantity of repetitions for the fourth message that is specific to the UE; or means for performing a decode operation for the fourth message of the four-step RACH procedure based at least in part on monitoring for the quantity of repetitions of the fourth message. Alternatively, the UE includes means for receiving, from a network node, signaling indicating that the network node supports UE-specific repetitions for a second message of a two-step RACH procedure; means for receiving, from the network node, DCI scheduling the second message, wherein the DCI comprises an indication of a quantity of repetitions for the second message that is specific to the UE; or means for performing a decode operation for the second message of the two-step RACH procedure based at least in part on monitoring for the quantity of repetitions of the second message.

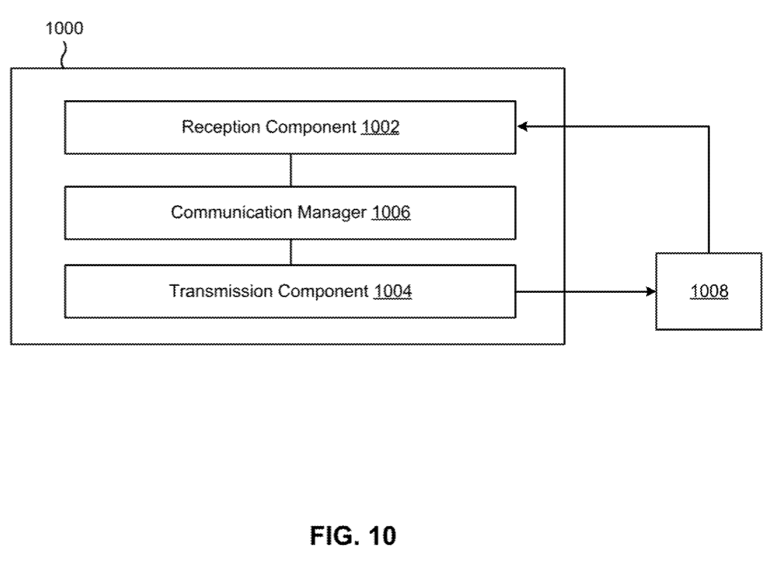

The means for the UE to perform operations described herein may include, for example, one or more of communication manager 150, processing system 140, a radio, one or more RF chains, one or more transceivers, one or more antennas, one or more modems, a reception component (for example, reception component 1002 depicted and described in connection with FIG. 10), or a transmission component (for example, transmission component 1004 depicted and described in connection with FIG. 10), among other examples.

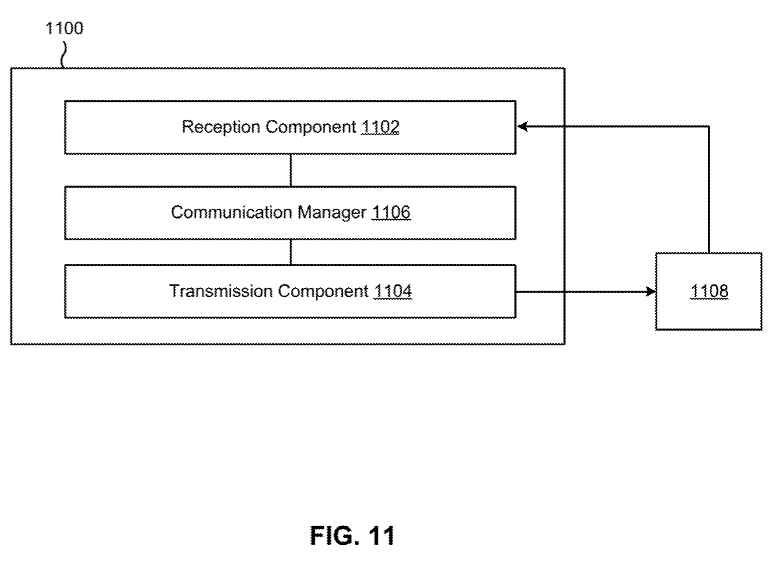

In some aspects, a network node includes means for transmitting, to a UE, signaling indicating that the network node supports UE-specific repetitions for a RACH transmission from the network node during a RACH procedure; means for transmitting, to the UE, DCI scheduling the RACH transmission from the network node, wherein the DCI comprises an indication of a quantity of repetitions for the RACH transmission that is specific to the UE; or means for transmitting the quantity of repetitions of the RACH transmission to the UE. The means for the network node to perform operations described herein may include, for example, one or more of communication manager 155, processing system 145, a radio, one or more RF chains, one or more transceivers, one or more antennas, one or more modems, a reception component (for example, reception component 1102 depicted and described in connection with FIG. 11), or a transmission component (for example, transmission component 1104 depicted and described in connection with FIG. 11), among other examples.

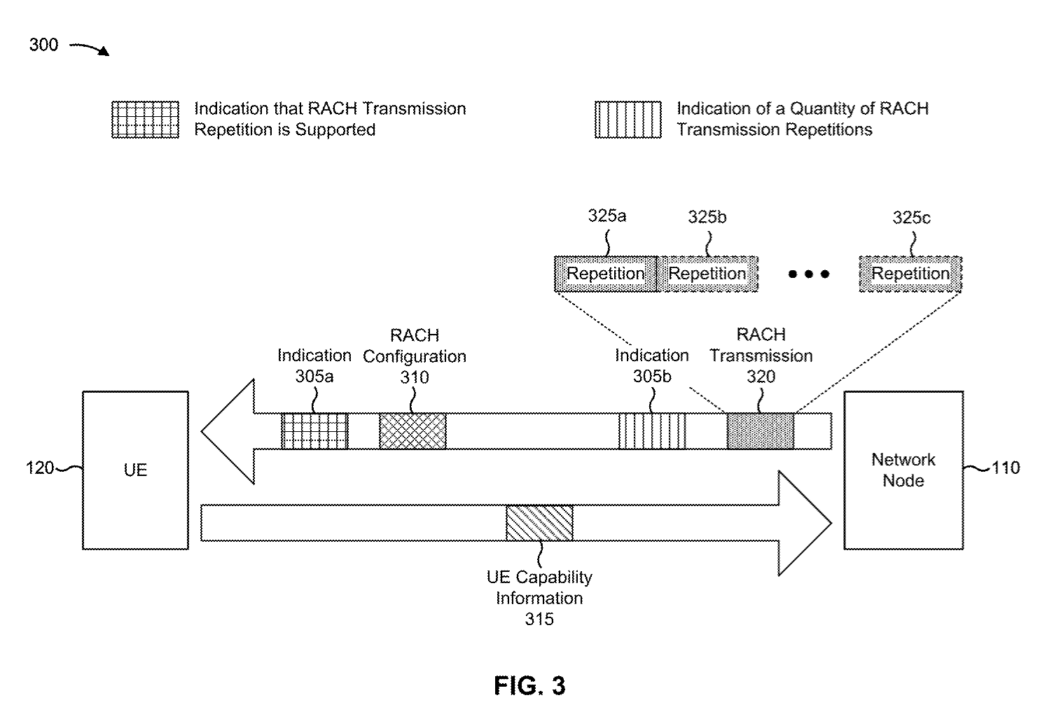

FIG. 3 is a diagram illustrating an example of a wireless communication network 300. The wireless communication network 300 may be or may include elements of the wireless communication network 100 described with reference to FIG. 1. The wireless communication network 300 may include a network node 110 and a UE 120, which may be examples of the network nodes and UEs, respectively, described with reference to FIG. 1.

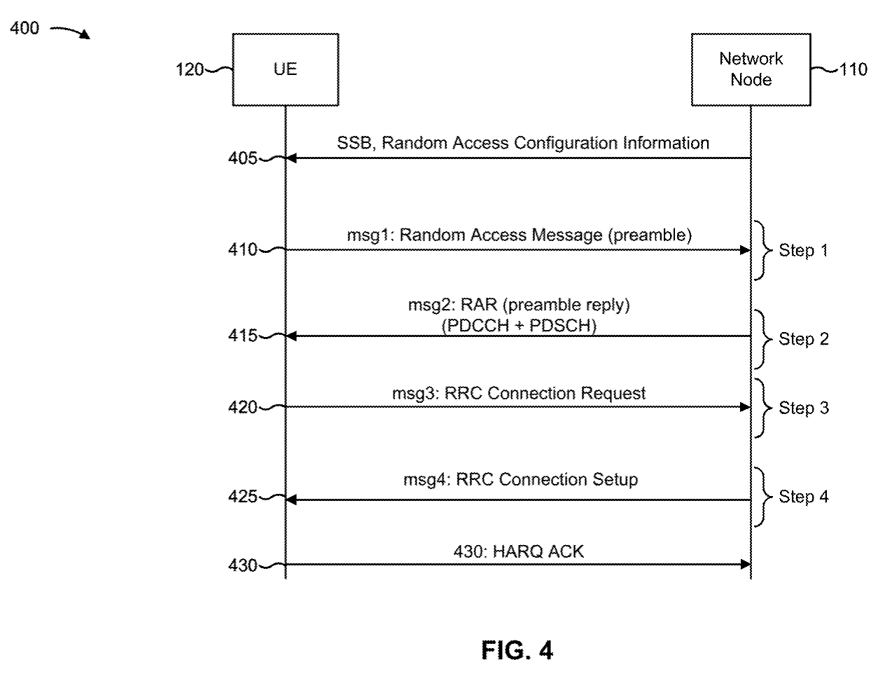

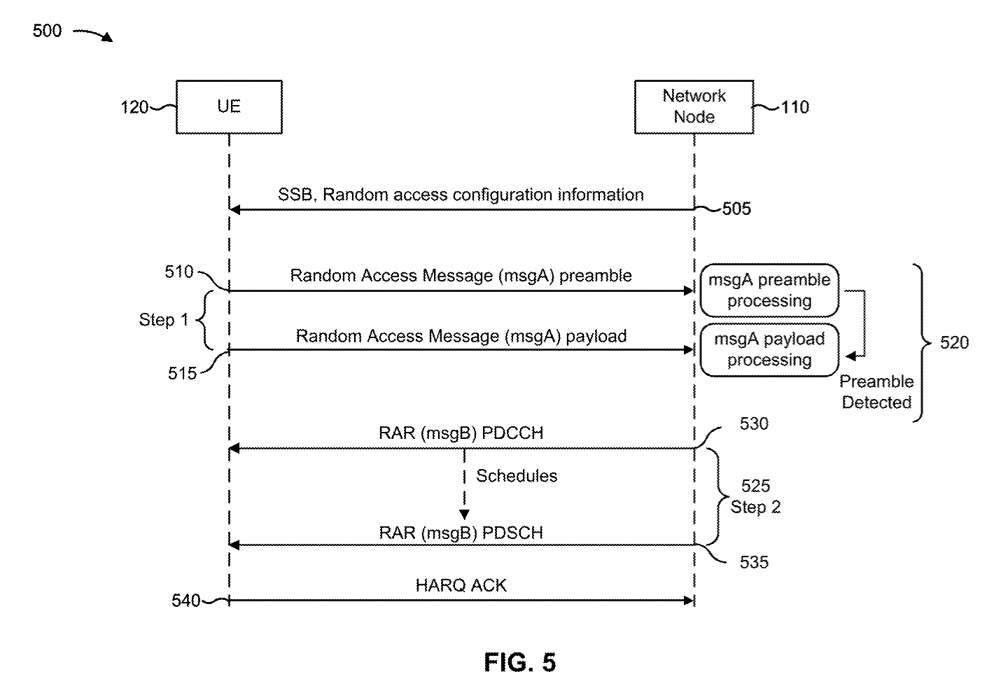

In the wireless communication network 300, the network node 110 may be capable of transmitting more than one repetition 325 of a RACH transmission 320 to the UE 120, and the quantity of repetitions 325 of the RACH transmission 320 may be specific to the UE 120. That is, in the example wireless communication network 300, the UE 120 may initiate a RACH procedure (e.g., a four-step RACH procedure or a two-step RACH procedure). During the RACH procedure, the network node 110 may transmit a UE-specific quantity of repetitions 325 of a RACH transmission 320 (e.g., a fourth message in a four-step RACH procedure, a second message or msgB in a two-step RACH procedure) during the RACH procedure. The details of the four-step RACH procedure are described with reference to FIG. 4 and the details of the two-step RACH procedure are described with reference to FIG. 5.

The network node 110 may transmit, and the UE 120 may receive, an indication 305a that RACH transmission repetition is supported by the network node 110. The network node 110 may transmit the indication 305a via a system information block (SIB) or via a RACH transmission. For example, the network node 110 may transmit the indication 305a via a SIB1 transmission. In another example, the network node 110 may transmit the indication 305a via a RACH transmission. For example, if the RACH procedure corresponds to a four-step RACH procedure, the network node 110 may transmit the indication 305a via a second message in the RACH procedure (e.g., a msg2, a random access response (RAR) message).

The network node 110 may also transmit signaling indicating a RACH configuration 310. The network node 110 may transmit RRC signaling, a SIB (e.g., SIB1), or a combination of RRC signaling and the SIB to indicate the RACH configuration 310. The RACH configuration 310 may indicate one or more parameters associated with the RACH procedure. For example, the RACH configuration 310 may indicate one or more resources for an initial transmission from the UE 120 to the network node 110 in the RACH procedure and a format for the initial transmission (e.g., a format for the initial transmission).

Additionally, the RACH configuration 310 may indicate a configuration associated with the UE 120 interpreting a field in a subsequent RACH transmission (such as the RACH transmission 320). In particular, the RACH transmission 320 may include a control transmission (e.g., DCI carried by a PDCCH) and a shared channel transmission (e.g., carried by a PDSCH). The DCI associated with the RACH transmission 320 may indicate a configuration associated with the shared channel transmission of the RACH transmission 320. The DCI associated with the RACH transmission 320 may include one or more fields, and the UE 120 may interpret each field based on a predefined or preconfigured table. For example, the UE 120 may identify a time domain resource allocation (TDRA) associated with the PDSCH portion of the RACH transmission 320 based on a row within a TDRA table that is indicated by an index within the TDRA field of the DCI. In another example, the UE 120 may identify an MCS associated with the PDSCH portion of the RACH transmission 320 based on a row within an MCS table that is indicated by an index indicated by an MCS field of the DCI.

To indicate the configuration associated with the UE 120 interpreting the field in the DCI of the RACH transmission 320, the RACH configuration 310 may indicate whether the UE 120 is to interpret a field in a subsequent RACH transmission based on a first table (e.g., that is predefined) or based on a second table (e.g., that is also predefined). Here, the network node 110 may transmit an indication of whether the UE 120 is to interpret the field in the DCI based on the first or second table via a flag within a SIB, such as SIB1. In an example where the field in the DCI corresponds to a TDRA field and the table corresponds to a TDRA table, the second table may also be configured to indicate a quantity of repetitions for the RACH transmission 320. For example, one or more of the rows in the first TDRA table may not be useful for low coverage scenarios. These rows may be redefined in the second TDRA table to indicate a quantity of repetitions for the PDCCH transmission 320.

Additionally, or alternatively, the network node 110 may indicate (e.g., via the SIB1) one or more updates to a table used by the UE 120 to interpret a field in the DCI of the RACH transmission 320. That is, the network node 110 may configure a full or partial override of rows within a default table. For example, the network node 110 may fully or partially override a quantity of rows within a default TDRA table or another table that is represented by a PDSCH-TimeDomainAllocationList that is carried in a PDSCH-ConfigCommon message. As described above, the network node 110 may override one or more rows in the default TDRA table that are not useful for the low coverage scenarios. Additionally, or alternatively, the network node 110 may indicate, via a SIB such as SIB1, a new table (e.g., that is different from a default table, that is different from a predefined table) for the UE 120 to use to interpret a field within the DCI of the RACH transmission 320.

The UE 120 may optionally transmit signaling indicating UE capability information 315 associated with repetitions 325 of the RACH transmission 320. For example, the UE 120 may transmit an indication that the UE 120 supports repetitions 325 of the RACH transmission 320. In some cases, the indication may indicate that the UE 120 supports the RACH transmission 320 having a quantity of repetitions 325 that is specific to the UE 120.

Additionally, or alternatively, the UE 120 may transmit a request for repetitions of the RACH transmission 320. The request for repetitions may correspond to a request for a UE-specific quantity of repetitions 325 of the RACH transmission 320. In some cases, the request may additionally include an indication of a requested quantity of repetitions 325 of the RACH transmission 320. The UE 120 may transmit the request for repetitions of the RACH transmission 320 based on a signal quality associated with a transmission received by the UE 120 from the network node 110. For example, the UE 120 may perform a measurement associated with the signal quality on the transmission received from the network node 110 (e.g., to identify a signal quality associated with downlink transmissions received from the network node 110). The UE 120 may perform an RSRP measurement, an SNR measurement, or some other type of signal quality measurement. The UE 120 may perform the measurement on an SSB received from the network node 110, on a second message of a four-step RACH procedure (e.g., an RAR) received from the network node 110, on a signal indicating a portion of the RACH configuration 310, or some other signal received from the network node 110. If the UE 120 determines that the measurement associated with signal quality of the transmission received from the network node 110 fails to satisfy a threshold, the UE 120 may transmit the request for repetitions of the RACH transmission 320.

In one example, the request may include a single bit (e.g., corresponding to a single codepoint) to request repetitions of the RACH transmission 320. In particular, the request may correspond to a flag, where a first value (e.g., ‘0’) indicates that the UE 120 is not requesting the repetitions 325, and a second value (e.g., ‘1’) indicates that the UE 120 is requesting the repetitions 325. Here, the network node 110 may determine a quantity of repetitions 325 of the RACH transmission 320. In another example, the request may include multiple bits (e.g., corresponding to multiple codepoints) to request a desired quantity of repetitions 325 of the RACH transmission 320. In particular, the network node 110 may indicate a set of possible repetition quantities (e.g., within a SIB, such as SIB1). Then, the UE 120 may set the multiple bits to a value that indicates one of the multiple codepoints. As an example, a first codepoint may indicate that the UE 120 is requesting a first quantity of repetitions, and a second codepoint may indicate that the UE 120 is requesting a second quantity of repetitions. Here, the network node 110 may transmit the requested quantity of repetitions 325 of the RACH transmission 320. In another example, the network node 110 may transmit a different quantity of repetitions 325 of the RACH transmission 320 than the requested quantity of repetitions. For example, an actual code rate may be higher than a lowest code rate assumed by the UE 120 for the request (e.g., if the quantity of resource blocks of the PDSCH portion of the RACH transmission 320 is small and a payload size of the PDSCH portion of the RACH transmission 320 is large). Here, the network node 110 may transmit more repetitions 325 of the RACH transmission 320 than requested by the UE 120.

The UE 120 may transmit the UE capability information 315 or the request for repetitions of the RACH transmission 320 within a RACH transmission from the UE 120 to the network node 110. For example, the UE 120 may transmit the UE capability information 315 or the request within a third message of a four-step RACH procedure (e.g., within an RRC connection request, within a msg3). In another example, the UE 120 may transmit the UE capability information 315 or the request within a first message of a two-step RACH procedure (e.g., within a random access message, within a msgA, within a random access message preamble, within a random access message payload). In particular, the UE 120 may indicate the UE capability information 315 or the request for repetitions of the RACH transmission 320 within the RACH transmission from the UE 120 via one or more bits in a field (e.g., via a codepoint) of the RACH transmission. For example, the UE 120 may indicate the UE capability information 315 or the request via one or more bits within a logical channel identifier (LCID) field (e.g., via one or more of the codepoints from 37 through 42 in the Table 6.2.1-2: “Values of LCID for UL-SCH when the LX field is not present or is set to 0” of 3GPP TS 38.321, V18.3.0, or via one or more of the codepoints from 8 through 63 in the Table 6.2.1-2c: “Values of LCID for UL-SCH when the LX field is set to 1” of 3GPP TS 38.321, V18.3.0) or an enhanced LCID (eLCID) field (e.g., of a msg3, of a msgA). That is, the UE capability information 315 or the request may be indicated by codepoints from reserved bits within an LCID or an eLCID field. In another example, the UE 120 may indicate the UE capability information 315 or the request within one or more reserved bits in a RACH transmission from the UE 120 (e.g., within one or more reserved bits within the msg3 or the msgA). As one example, the UE capability information 315 or the request may be indicated in a spare bit in an RRC setup request message or an RRC resume request message.

In another example, the UE 120 may indicate the UE capability information 315 or the request for repetitions of the RACH transmission 320 via a PRACH sequence selected by the UE 120 for the initial RACH transmission by the UE 120 to the network node 110 (e.g., a preamble transmission within msg1 or msgA). In particular, one or more PRACH partitions (e.g., a subset of the PRACH sequencies) may be configured such that selecting the PRACH sequences from the PRACH partition may indicate, to the network node 110, that the UE 120 is capable of supporting repetitions of the RACH transmission 320 or that the UE 120 is requesting repetitions of the RACH transmission 320.

The network node 110 may determine a quantity of repetitions 325 for the RACH transmission 320. For example, the network node 110 may determine that the UE 120 is capable of supporting multiple repetitions of the RACH transmission 320, and may determine the quantity of repetitions 325 for the RACH transmission 320. If the UE 120 transmits a request that includes a requested quantity of repetitions 325 for the RACH transmission 320, the network node 110 may determine the quantity of repetitions 325 based on the request. Additionally, or alternatively, the network node 110 may determine the quantity of the repetitions 325 based on a signal quality associated with a transmission received from the UE 120. For example, the network node 110 may perform a measurement associated with the signal quality on the transmission received from the UE 120 (e.g., to identify a signal quality associated with uplink transmissions received from the UE 120). The network node 110 may perform an RSRP measurement, an SNR measurement, or some other type of signal quality measurement. The network node 110 may perform the measurement on an initial RACH transmission received from the UE 120 (e.g., a msg1, a msgA), or some other signal received from the UE 120. The network node 110 may determine the quantity of the repetitions based on the measured signal quality.

The network node 110 may transmit an indication 305b of the quantity of repetitions 325 of the RACH transmission 320. The network node 110 may transmit the indication 305b within DCI associated with the RACH transmission 320. In particular, the network node 110 may transmit a PDCCH communication for the RACH transmission 320. The PDCCH communication carry the DCI. For a four-step RACH procedure, the DCI may correspond to DCI 1_0 that is encoded with a temporary cell radio network identifier (TC-RNTI). Additionally, for a two-step RACH procedure, the DCI may correspond to a DCI 1_0 that is encoded with a cell radio network identifier (C-RNTI) or a msgB radio network identifier. The UE 120 may monitor for the DCI and decode the DCI using the TC-RNTI. The DCI may include a set of fields that are configured to indicate various parameters associated with the RACH transmission 320 (e.g., associated with the RACH transmission 320 that is communicated via a PDSCH). For example, the DCI may include a TDRA field configured to indicate a TDRA associated with the RACH transmission 320 or an MCS field configured to indicate an MCS associated with the RACH transmission 320.

The indication 305b may be carried within a field of the DCI that is not dedicated to carrying indications of a quantity of repetitions of the RACH transmission 320. The UE 120 may identify the indication 305b based on reinterpreting the field of the DCI. For example, the network node 110 may indicate, to the UE 120, a configuration for interpreting the field in the DCI (e.g., via the RACH configuration 310 or via a SIB such as SIB1). The UE 120 may determine to interpret the field in the DCI as including the indication 305b based on indicating, to the network node 110, that the UE 120 supports repetitions 325 of the RACH transmission 320. Accordingly, UEs 120 that are capable of receiving repetitions 325 of RACH transmissions 320 may interpret the field in the DCI to identify the indication 305b while UEs 120 that are not capable of receiving repetitions 325 of RACH transmissions 320 may not identify the indication 305b.

In one example, the indication 305b may be carried within a TDRA field of the DCI. In an example where the TDRA field is not carrying the indication 305b, the UE 120 may interpret the TDRA field within the DCI based on a TDRA table. For example, one or more bits in the TDRA field may correspond to an index that points to a row within the TDRA table that indicates the TDRA for the RACH transmission 320. If the TDRA field is carrying the indication 305b, one or more rows in the TDRA table be associated with a quantity of repetitions for the RACH transmission 320. For example, one or more rows of the TDRA table may be defined or configured to be associated with or indicative of a quantity of repetitions of the RACH transmission (e.g., of a msg4, of a msgB). Here, the indication 305b may correspond to an index that points to one of the rows of the TDRA table that are associated with a quantity of repetitions for the RACH transmission 320.

In some cases, the row indicated by the TDRA field may indicate both a quantity of the repetitions 325 and the TDRA for the RACH transmission 320. In some other cases, the row indicated by the TDRA field may indicate the quantity of repetitions 325 and may not indicate the TDRA for the RACH transmission 320. If the row in the TDRA table does not indicate the TDRA for the RACH transmission 320, the UE 120 may determine the TDRA for the RACH transmission 320 as a default TDRA configuration (e.g., a default row in the TDRA table).

In some cases, the row indicated by the TDRA field may indicate both a quantity of the repetitions 325 and the TDRA for the RACH transmission 320. In some other cases, the row indicated by the TDRA field may indicate the quantity of repetitions 325 and may not indicate the TDRA for the RACH transmission 320. If the row in the TDRA table does not indicate the TDRA for the RACH transmission 320, the UE 120 may determine the TDRA for the RACH transmission 320 as a default TDRA configuration (e.g., a default row in the TDRA table).

In another example, the indication 305b may be carried within an MCS field of the DCI. In an example where the MCS field is not carrying the indication 305b, the UE 120 may interpret the bits in the MCS field to indicate an index that points to an MCS table. For example, one or more bits in the MCS field may correspond to an index that points to a row within the MCS table that indicates the MCS for the RACH transmission 320. If the MCS field is carrying the indication 305b, one or more bits in the MCS field (e.g., one or more of the most significant bits in the MCS field) may indicate the quantity of repetitions of the RACH transmission 320 and the remaining bits in the MCS field may indicate the MCS for the RACH transmission 320. In some cases, fewer bits may be used by the network node 110 to indicate the MCS for the RACH transmission 320 based on the network node 110 indicating repetitions during low coverage scenarios, and fewer different MCS configurations may be useful during the low coverage scenarios (e.g., the MCS indices corresponding to high spectral efficiency may not be used for low coverage scenarios). In some cases, the MCS field may not carry an indication of the MCS for the RACH transmission 320. Here, the UE 120 may determine the MCS for the RACH transmission 320 as a default MCS configuration (which may correspond to a lowest spectral efficiency MCS).

The network node 110 may then transmit one or more repetitions 325 of the RACH transmission 320. In one example, the indication 305b may indicate that there is one repetition 325a of the RACH transmission 320. Here, the network node 110 may transmit the repetition 325a and may not transmit any additional repetitions 325 of the RACH transmission 320. In another example, the indication 305b may indicate that there is more than one repetition 325 of the RACH transmission (e.g., the repetition 325a, the repetition 325b, and the repetition 325c).

The RACH transmission 320 may correspond to a PDSCH transmission that is sent by the network node 110, during the RACH procedure, prior to a completion of an RRC setup between the UE 120 and the network node 110. In one example where the RACH procedure corresponds to a four-step RACH procedure, the RACH transmission 320 may include a contention resolution MAC CE and an RRC message (e.g., an RRCSetup message). In another example where the RACH procedure corresponds to the four-step RACH procedure, the RACH transmission 320 may include a PDSCH that includes the RRC message without the contention resolution MAC CE. In particular, the RACH transmission 320 may not include the contention resolution MAC CE if a previous msg4 contains the contention resolution MAC CE.

The UE 120 may monitor for the quantity of repetitions 325 of the RACH transmission 320 and may perform a decode operation for the RACH transmission 320 based on detecting one or more of the repetitions 325.

As used herein, the UE 120 performing the decode operation may include the UE 120 attempting to decode the RACH transmission 320. For example, the UE 120 may initiate a decode attempt of the RACH transmission 320. Based on monitoring the quantity of repetitions, the UE 120 may decode the RACH transmissions 320 based on the UE 120 detecting the quantity of repetitions 325. In other words, the UE 120 proceeds with decoding the RACH transmission 320 if the quantity of repetitions 325 are detected by the UE 120.

As indicated above, FIG. 3 is provided as an example. Other examples may differ from what is described with respect to FIG. 3.

FIG. 4 is a diagram illustrating an example 400 of a four-step random access procedure. As shown in FIG. 4, a network node 110 and a UE 120 may communicate with one another to perform the four-step random access procedure. In the example 400, the network node 110 may transmit a quantity of repetitions of a fourth message (e.g., msg4) that is specific to the UE 120.

As shown by reference number 405, the network node 110 may transmit, and the UE 120 may receive, one or more SSBs and random access configuration information. In some aspects, the random access configuration information may be transmitted in or indicated by system information (e.g., in one or more SIBs) or an SSB, such as for contention-based random access. Additionally, or alternatively, the random access configuration information may be transmitted in an RRC message or a PDCCH order message that triggers a RACH procedure, such as for contention-free random access. The random access configuration information may include one or more parameters to be used in the random access procedure, such as one or more parameters for transmitting a random access message or one or more parameters for receiving an RAR.

The random access configuration information may additionally indicate a capability of the network node 110 to transmit a quantity of repetitions of a fourth message of the RACH procedure (e.g., the msg4 shown by reference number 425) that is specific to the UE 120. Additionally, the random access configuration may indicate, to the UE 120, a configuration for interpreting one or more fields of the DCI within the msg4. For example, the random access configuration may indicate whether the UE 120 is to interpret a field within the DCI (e.g., a TDRA field, an MCS field) according to a first or second table. Additionally, or alternatively, the random access configuration may indicate one or more updates to a previously-defined or previously-configured table, and may indicate for the UE 120 to interpret one or more fields in the DCI according to the updated table. Additionally, or alternatively, the random access configuration may indicate a new table (e.g., that is different from a previously defined or configured table) for the UE 120 to use when interpreting a field in the DCI.

As shown by reference number 410, the UE 120 may transmit a random access message, which may include a preamble (sometimes referred to as a random access preamble, a PRACH preamble, or a random access message preamble). The message that includes the preamble may be referred to as a message 1, msg1, msg1, a first message, or an initial message in a four-step random access procedure. The random access message may include a random access preamble identifier. In some cases, the UE 120 may indicate, within the random access message, a capability of the UE 120 to support repetitions of the msg4. Additionally, or alternatively, the UE 120 may indicate, within the random access message, a request for repetitions of the msg4. In some cases, the UE 120 may indicate the capability of the UE 120 or the request via one or more bits within the random access message. Additionally, or alternatively, the UE 120 may indicate the capability or the request based on a PRACH sequence of the random access message. In particular, one or more of the PRACH sequences may be configured to indicate, to the network node 110, that the UE 120 is capable of supporting repetitions of the msg4 or that the UE 120 is requesting repetitions of the msg4.

As shown by reference number 415, the network node 110 may transmit an RAR as a reply to the preamble. The message that includes the RAR may be referred to as message 2, msg2, msg2, or a second message in a four-step random access procedure. In some aspects, the RAR may indicate the detected random access preamble identifier (e.g., received from the UE 120 in msg1). Additionally, or alternatively, the RAR may indicate a resource allocation to be used by the UE 120 to transmit message 3 (msg3).

In some aspects, as part of the second step of the four-step random access procedure, the network node 110 may transmit a PDCCH communication for the RAR. The PDCCH communication may schedule a PDSCH communication that includes the RAR. For example, the PDCCH communication may indicate a resource allocation for the PDSCH communication. Also as part of the second step of the four-step random access procedure, the network node 110 may transmit the PDSCH communication for the RAR, as scheduled by the PDCCH communication. The RAR may be included in a MAC PDU of the PDSCH communication.

As shown by reference number 420, the UE 120 may transmit an RRC connection request message. The RRC connection request message may be referred to as message 3, msg3, msg3, or a third message of a four-step random access procedure. In some aspects, the RRC connection request may include a UE identifier, UCI, or a PUSCH communication (e.g., an RRC connection request). In some cases, the UE 120 may indicate, within RRC connection request, a capability of the UE 120 to support repetitions of the msg4. Additionally, or alternatively, the UE 120 may indicate, within the RRC connection request, a request for repetitions of the msg4. In some cases, the UE 120 may indicate the capability of the UE 120 or the request via one or more bits within the RRC connection request.

As shown by reference number 425, the network node 110 may transmit an RRC connection setup message. The RRC connection setup message may be referred to as message 4, msg4, msg4, or a fourth message of a four-step random access procedure. The RRC connection setup message may correspond to a message that includes a contention resolution MAC CE and an RRC setup message (e.g., an RRCSetup RRC message). Alternatively, the RRC connection setup message may correspond to a message that includes the RRC setup message and does not include the contention resolution MAC CE. In some aspects, the RRC connection setup message may include the detected UE identifier, a timing advance value, or contention resolution information. For example, if both the UE 120 and a second UE 120 collide (e.g., transmit a msg3 in a same occasion), the network node 110 may successfully decode the msg3 from the UE 120 and fail to successfully decode the msg3 from the second UE. Then, the network node 110 may transmit the RRC connection setup message, which may include a contention resolution MAC CE that indicates that the RRC connection setup message if for the UE 120 (e.g., and not the second UE).

In some aspects, as part of the fourth step of the four-step random access procedure, the network node 110 may transmit a PDCCH communication for the RRC connection setup message. The UE 120 may decode the PDCCH communication with the TC-RNTI. The PDCCH may schedule a PDSCH communication that includes the RRC connection setup message. For example, the PDCCH communication may indicate a resource allocation for the RRC connection setup message. Additionally, the PDCCH communication may indicate a quantity of repetitions of a PDSCH communication that includes the RRC connection setup message. The quantity of repetitions of the PDSCH communication may be specific to the UE 120 and based on a channel quality between the UE 120 and the network node 110 (e.g., and based on a measurement associated with the channel quality performed by the UE 120 or performed by the network node 110).

Additionally, as part of the fourth step of the four-step random access procedure, the network node 110 may transmit the PDSCH communication for the RRC connection setup message, as scheduled by the PDCCH communication. The RRC connection setup message may be included in a MAC CE of the PDSCH communication. The network node 110 may transmit a quantity of repetitions of the PDSCH communication for the RRC connection setup message in accordance with the indication provided to the UE 120 within the PDCCH communication.

As shown by reference number 430, if the UE 120 successfully receives the RRC connection setup message, the UE 120 may transmit a HARQ ACK.

As indicated above, FIG. 4 is provided as an example. Other examples may differ from what is described with regard to FIG. 4.

FIG. 5 is a diagram illustrating an example 500 of a two-step random access procedure. As shown in FIG. 5, a network node 110 and a UE 120 may communicate with one another to perform the two-step random access procedure. In the example 500, the network node 110 may transmit a quantity of repetitions of a second message (e.g., msgB) that is specific to the UE 120.

As shown by reference number 505, the network node 110 may transmit, and the UE 120 may receive, one or more SSBs and random access configuration information. In some aspects, the random access configuration information may be transmitted in or indicated by system information (e.g., in one or more SIBs) or an SSB, such as for contention-based random access. Additionally, or alternatively, the random access configuration information may be transmitted in an RRC message or PDCCH order message that triggers a RACH procedure, such as for contention-free random access. The random access configuration information may include one or more parameters to be used in the two-step random access procedure, such as one or more parameters for transmitting a random access message or receiving an RAR to the random access message.

The random access configuration information may additionally indicate a capability of the network node 110 to transmit a quantity of repetitions of a fourth message of the RACH procedure (e.g., the RAR PDSCH shown by reference number 535) that is specific to the UE 120. Additionally, the random access configuration may indicate, to the UE 120, a configuration for interpreting one or more fields of the RAR PDCCH shown at 530 (e.g., one or more fields of the DCI within the RAR PDCCH). For example, the random access configuration may indicate whether the UE 120 is to interpret a field within the DCI (e.g., a TDRA field, an MCS field) according to a first or second table. Additionally, or alternatively, the random access configuration may indicate one or more updates to a previously-defined or previously-configured table, and may indicate for the UE 120 to interpret one or more fields in the DCI according to the updated table. Additionally, or alternatively, the random access configuration may indicate a new table (e.g., that is different from a previously defined or configured table) for the UE 120 to use when interpreting a field in the DCI.

As shown by reference number 510, the UE 120 may transmit, and the network node 110 may receive, a random access message preamble. As shown by reference number 515, the UE 120 may transmit, and the network node 110 may receive, a random access message payload. As shown, the UE 120 may transmit the random access message preamble and the random access message payload to the network node 110 as part of an initial (or first) step of the two-step random access procedure. In some aspects, the random access message may be referred to as message A, msgA, a first message, or an initial message in a two-step random access procedure. Furthermore, in some aspects, the random access message preamble may be referred to as a message A preamble, a msgA preamble, a preamble, or a PRACH preamble, and the random access message payload may be referred to as a message A payload, a msgA payload, or a payload. In some aspects, the random access message may include some or all of the contents of message 1 (msg1) and message 3 (msg3) of a four-step random access procedure, which is described in more detail below. For example, the random access message preamble may include some or all contents of message 1 (e.g., a PRACH preamble), and the random access message payload may include some or all contents of message 3 (e.g., a UE identifier, uplink control information (UCI), or a physical uplink shared channel (PUSCH) transmission).

In some cases, the UE 120 may indicate, within the random access message preamble or payload, a capability of the UE 120 to support repetitions of msgB (e.g., the RAR PDSCH). Additionally, or alternatively, the UE 120 may indicate, within the random access message, a request for repetitions of the msgB. In some cases, the UE 120 may indicate the capability of the UE 120 or the request via one or more bits within the random access message. Additionally, or alternatively, the UE 120 may indicate the capability or the request based on a PRACH sequence of the random access message preamble. In particular, one or more of the PRACH sequences may be configured to indicate, to the network node 110, that the UE 120 is capable of supporting repetitions of the msgB or that the UE 120 is requesting repetitions of the msg4.

As shown by reference number 520, the network node 110 may receive the random access message preamble transmitted by the UE 120. If the network node 110 successfully receives and decodes the random access message preamble, the network node 110 may then receive and decode the random access message payload.

As shown by reference number 525, the network node 110 may transmit an RAR (sometimes referred to as an RAR message). As shown, the network node 110 may transmit the RAR message as part of a second step of the two-step random access procedure. In some aspects, the RAR message may be referred to as message B, msgB, or a second message in a two-step random access procedure. The RAR message may include some or all of the contents of message 2 (msg2) and message 4 (msg4) of a four-step random access procedure. For example, the RAR message may include the detected PRACH preamble identifier, the detected UE identifier, a timing advance value, or contention resolution information.

As shown by reference number 530, as part of the second step of the two-step random access procedure, the network node 110 may transmit a PDCCH communication for the RAR. The PDCCH communication may schedule a PDSCH communication that includes the RAR. For example, the PDCCH communication may indicate a resource allocation (e.g., in DCI) for the PDSCH communication. Additionally, the PDCCH communication may indicate a quantity of repetitions of the PDSCH communication that includes the RAR. The quantity of repetitions of the PDSCH communication may be specific to the UE 120 and based on a channel quality between the UE 120 and the network node 110 (e.g., and based on a measurement associated with the channel quality performed by the UE 120 or performed by the network node 110).

As shown by reference number 535, as part of the second step of the two-step random access procedure, the network node 110 may transmit the PDSCH communication for the RAR, as scheduled by the PDCCH communication. The RAR may be included in a MAC protocol data unit (PDU) of the PDSCH communication. In some cases, the PDSCH communication may include an RRC setup message (e.g., an RRCSetup RRC message). The network node 110 may transmit a quantity of repetitions of the PDSCH communication for the RAR in accordance with the indication provided to the UE 120 within the PDCCH communication for the RAR.

As shown by reference number 540, if the UE 120 successfully receives the RAR, the UE 120 may transmit a hybrid automatic repeat request (HARQ) acknowledgement (ACK).

As indicated above, FIG. 5 is provided as an example. Other examples may differ from what is described with regard to FIG. 5.

FIG. 6 is a diagram illustrating an example process 600 performed, for example, at a UE or an apparatus of a UE. Example process 600 is an example where the apparatus or the UE (e.g., UE 120) performs operations associated with repetitions of RACH transmissions.

As shown in FIG. 6, in some aspects, process 600 may include receiving, from a network node, signaling indicating that the network node supports UE-specific repetitions for a RACH transmission from the network node during a RACH procedure (block 610). For example, the UE (e.g., using reception component 1002 or communication manager 1006, depicted in FIG. 10) may receive, from a network node, signaling indicating that the network node supports UE-specific repetitions for a RACH transmission from the network node during a RACH procedure, as described above.

As further shown in FIG. 6, in some aspects, process 600 may include receiving, from the network node, DCI scheduling the RACH transmission from the network node, wherein the DCI comprises an indication of a quantity of repetitions for the RACH transmission that is specific to the UE (block 620). For example, the UE (e.g., using reception component 1002 or communication manager 1006, depicted in FIG. 10) may receive, from the network node, DCI scheduling the RACH transmission from the network node, wherein the DCI comprises an indication of a quantity of repetitions for the RACH transmission that is specific to the UE, as described above.

As further shown in FIG. 6, in some aspects, process 600 may include performing a decode operation for the RACH transmission based at least in part on monitoring for the quantity of repetitions of the RACH transmission (block 630). For example, the UE (e.g., using communication manager 1006, depicted in FIG. 10) may perform a decode operation for the RACH transmission based at least in part on monitoring for the quantity of repetitions of the RACH transmission, as described above.

Process 600 may include additional aspects, such as any single aspect or any combination of aspects described below or in connection with one or more other processes described elsewhere herein.

In a first aspect, the RACH transmission comprises a PDSCH transmission that is received from the network node prior to a completion of a setup of a RRC connection between the UE and network node.

In a second aspect, alone or in combination with the first aspect, the RACH procedure is a four-step RACH procedure and the PDSCH transmission is a message 4 in the four-step RACH procedure, and the message 4 corresponds to a first message that comprises a contention resolution MAC CE and an RRC setup message or corresponds to a second message that comprises the RRC setup message and does not comprise the contention resolution MAC CE.

In a third aspect, alone or in combination with the first aspect, the RACH procedure is a two-step RACH procedure and the PDSCH transmission is a message B in the two-step RACH procedure, and the message B comprises an RRC setup message.

In a fourth aspect, alone or in combination with one or more of the first through third aspects, the process 600 includes transmitting, to the network node, UE capability information indicating that the UE supports the UE-specific repetitions for the RACH transmission, wherein the DCI comprises the indication of the quantity of repetitions based at least in part on the UE supporting the UE-specific repetitions for the RACH transmission.

In a fifth aspect, alone or in combination with one or more of the first through the fourth aspects, transmitting the UE capability information comprises transmitting the UE capability information within a physical uplink shared channel transmission of the RACH procedure.

In a sixth aspect, alone or in combination with one or more of the first through fifth aspects, process 600 includes transmitting, to the network node, a request for the UE-specific repetitions for the RACH transmission, wherein the DCI comprises the indication of the quantity of repetitions based at least in part on the request.

In a seventh aspect, alone or in combination with one or more of the first through sixth aspects, the request further comprises a requested quantity of the repetitions for the RACH transmission.

In an eighth aspect, alone or in combination with one or more of the first through seventh aspects, transmitting the request comprises transmitting the request within a physical uplink shared channel transmission of the RACH procedure.

In a ninth aspect, alone or in combination with one or more of the first through eighth aspects, transmitting the request is based at least in part on transmitting a PRACH sequence that is indicative of the request.

In a tenth aspect, alone or in combination with one or more of the first through eighth aspects, the indication of the quantity of repetitions for the RACH transmission is within a field of the DCI that is not dedicated to the indication of the quantity of repetitions for the RACH transmission, and process 600 includes interpreting the field as comprising the indication of the quantity of repetitions based at least in part on receiving the signaling indicating that the network node supports UE-specific repetitions for the RACH transmission.

In an eleventh aspect, alone or in combination with one or more of the first through tenth aspects, process 600 includes transmitting, to the network node, signaling indicating that the UE supports the UE-specific repetitions for the RACH transmission or requesting the UE-specific repetitions for the RACH transmission, wherein interpreting the field as comprising the indication of the quantity of repetitions is based at least in part on the transmitting.

In a twelfth aspect, alone or in combination with one or more of the first through eleventh aspects, a TDRA within the DCI comprises the indication of the quantity of repetitions for the RACH transmission, and process 600 includes interpreting the TDRA as comprising the indication of the quantity of repetitions for the RACH transmission based at least in part on receiving the signaling indicating that the network node supports UE-specific repetitions for the RACH transmission.

In a thirteenth aspect, alone or in combination with one or more of the first through twelfth aspects, the TDRA indicates a row within a TDRA table that is indicative of the quantity of repetitions for the RACH transmission.

In a fourteenth aspect, alone or in combination with one or more of the first through thirteenth aspects, the row within the TDRA table that is indicative of the quantity of repetitions for the RACH transmission is not indicative of the TDRA for the RACH transmission, and process 600 includes identifying that the TDRA for the RACH transmission corresponds to a default TDRA based at least in part on the row within the TDRA table not being indicative of the TDRA for the RACH transmission.

In a fifteenth aspect, alone or in combination with one or more of the first through fourteenth aspects, the row within the TDRA table is further indicative of the TDRA for the RACH transmission.

In a sixteenth aspect, alone or in combination with one or more of the first through fifteenth aspects, process 600 includes determining whether to interpret the TDRA based at least in part on a first TDRA table or a second TDRA table, wherein interpreting the TDRA is based at least in part on determining to interpret the TDRA based on the second TDRA table.

In a seventeenth aspect, alone or in combination with one or more of the first through sixteenth aspects, process 600 includes receiving signaling from the network node configuring the second TDRA table.

In an eighteenth aspect, alone or in combination with one or more of the first through seventeenth aspects, an MCS index within the DCI comprises the indication of the quantity of repetitions for the RACH transmission, and process 600 includes interpreting the MCS index as comprising the indication of the quantity of repetitions for the RACH transmission based at least in part on receiving the signaling indicating that the network node supports UE-specific repetitions for the RACH transmission.

In a nineteenth aspect, alone or in combination with one or more of the first through eighteenth aspects, one or more bits of the MCS index indicate the quantity of repetitions for the RACH transmission, and one or more bits of the MCS index indicate an MCS of the RACH transmission.

In a twentieth aspect, alone or in combination with one or more of the first through nineteenth aspects, the MCS index is not indicative of an MCS of the RACH transmission, and process 600 includes identifying that the MCS of the RACH transmission corresponds to a default MCS based at least in part on the MCS index not being indicative of the MCS of the RACH transmission.

In a twenty-first aspect, alone or in combination with one or more of the first through twentieth aspects, process 600 includes determining whether to interpret the MCS index based at least in part on a first MCS table or a second MCS table, wherein interpreting the MCS index is based at least in part on determining to interpret the MCS index based at least in part on the second MCS table.

In a twenty-second aspect, alone or in combination with one or more of the first through twenty-first aspects, process 600 includes receiving signaling from the network node configuring the second MCS table.

In a twenty-third aspect, alone or in combination with one or more of the first through twenty-second aspects, performing the decode operation includes decoding the RACH transmission.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram illustrating an example process 700 performed, for example, at a UE or an apparatus of a UE. Example process 700 is an example where the apparatus or the UE (e.g., UE 120) performs operations associated with repetitions of RACH transmissions.

As shown in FIG. 7, in some aspects, process 700 may include receiving, from a network node, signaling indicating that the network node supports UE-specific repetitions for a fourth message of a four-step RACH procedure (block 710). For example, the UE (e.g., using reception component 1002 or communication manager 1006, depicted in FIG. 10) may receive, from a network node, signaling indicating that the network node supports UE-specific repetitions for a fourth message of a four-step RACH procedure, as described above.

As further shown in FIG. 7, in some aspects, process 700 may include receiving, from the network node, DCI scheduling the fourth message, wherein the DCI comprises an indication of a quantity of repetitions for the fourth message that is specific to the UE (block 720). For example, the UE (e.g., using reception component 1002 or communication manager 1006, depicted in FIG. 10) may receive, from the network node, DCI scheduling the fourth message, wherein the DCI comprises an indication of a quantity of repetitions for the fourth message that is specific to the UE, as described above.

As further shown in FIG. 7, in some aspects, process 700 may include performing a decode operation for the fourth message of the four-step RACH procedure based at least in part on monitoring for the quantity of repetitions of the fourth message (block 730). For example, the UE (e.g., using communication manager 1006, depicted in FIG. 10) may perform a decode operation for the fourth message of the four-step RACH procedure based at least in part on monitoring for the quantity of repetitions of the fourth message, as described above.

Process 700 may include additional aspects, such as any single aspect or any combination of aspects described below or in connection with one or more other processes described elsewhere herein.

In a first aspect, process 700 includes transmitting, to the network node, UE capability information indicating that the UE supports the UE-specific repetitions for the fourth message, wherein the DCI comprises the indication of the quantity of repetitions based at least in part on the UE supporting the UE-specific repetitions for the fourth message.

In a second aspect, alone or in combination with the first aspect, the UE capability information is within a third message of the four-step RACH procedure.

In a third aspect, alone or in combination with one or more of the first and second aspects, transmitting the UE capability information is based at least in part on transmitting a PRACH sequence that is indicative of the UE capability information.

In a fourth aspect, alone or in combination with one or more of the first through third aspects, process 700 includes transmitting, to the network node, a request for the UE-specific repetitions for the fourth message, wherein the DCI comprises the indication of the quantity of repetitions based at least in part on the request.

In a fifth aspect, alone or in combination with one or more of the first through fourth aspects, process 700 includes performing a measurement associated with a signal quality of a second message of the four-step RACH procedure, wherein requesting the UE-specific repetitions for the fourth message is based at least in part on the measurement failing to satisfy a threshold.

In a sixth aspect, alone or in combination with one or more of the first through fifth aspects, the request further comprises a requested quantity of the repetitions for the fourth message.

In a seventh aspect, alone or in combination with one or more of the first through sixth aspects, the request is within a third message of the four-step RACH procedure.

In an eighth aspect, alone or in combination with one or more of the first through seventh aspects, transmitting the request is based at least in part on transmitting a PRACH sequence that is indicative of the request.

In a ninth aspect, alone or in combination with one or more of the first through eighth aspects, the indication of the quantity of repetitions for the fourth message is within a field of the DCI that is not dedicated to the indication of the quantity of repetitions for the fourth message, and process 700 includes interpreting the field as comprising the indication of the quantity of repetitions based at least in part on receiving the signaling indicating that the network node supports UE-specific repetitions for the fourth message.

In a tenth aspect, alone or in combination with one or more of the first through ninth aspects, process 700 includes transmitting, to the network node, signaling indicating that the UE supports the UE-specific repetitions for the fourth message or requesting the UE-specific repetitions for the fourth message, wherein interpreting the field as comprising the indication of the quantity of repetitions is based at least in part on the transmitting.

In an eleventh aspect, alone or in combination with one or more of the first through tenth aspects, a TDRA within the DCI comprises the indication of the quantity of repetitions for the fourth message, and process 700 includes interpreting the TDRA as comprising the indication of the quantity of repetitions for the fourth message based at least in part on receiving the signaling indicating that the network node supports UE-specific repetitions for the fourth message.

In a twelfth aspect, alone or in combination with one or more of the first through eleventh aspects, the TDRA indicates a row within a TDRA table that is indicative of the quantity of repetitions for the fourth message.

In a thirteenth aspect, alone or in combination with one or more of the first through twelfth aspects, the row within the TDRA table that is indicative of the quantity of repetitions for the fourth message is not indicative of the TDRA for the fourth message, and process 700 includes identifying that the TDRA for the fourth message corresponds to a default TDRA based at least in part on the row within the TDRA table not being indicative of the TDRA for the fourth message.

In a fourteenth aspect, alone or in combination with one or more of the first through thirteenth aspects, the row within the TDRA table is further indicative of the TDRA for the fourth message.

In a fifteenth aspect, alone or in combination with one or more of the first through fourteenth aspects, process 700 includes determining whether to interpret the TDRA based at least in part on a first TDRA table or a second TDRA table, wherein interpreting the TDRA is based at least in part on determining to interpret the TDRA based on the second TDRA table.

In a sixteenth aspect, alone or in combination with one or more of the first through fifteenth aspects, process 700 includes receiving signaling from the network node configuring the second TDRA table.

In a seventeenth aspect, alone or in combination with one or more of the first through sixteenth aspects, an MCS index within the DCI comprises the indication of the quantity of repetitions for the fourth message, and process 700 includes interpreting the MCS index as comprising the indication of the quantity of repetitions for the fourth message based at least in part on receiving the signaling indicating that the network node supports UE-specific repetitions for the fourth message.

In an eighteenth aspect, alone or in combination with one or more of the first through seventeenth aspects, one or more bits of the MCS index indicate the quantity of repetitions for the fourth message, and one or more bits of the MCS index indicate an MCS of the fourth message.

In a nineteenth aspect, alone or in combination with one or more of the first through eighteenth aspects, the MCS index is not indicative of an MCS of the fourth message, and process 700 includes identifying that the MCS of the fourth message corresponds to a default MCS based at least in part on the MCS index not being indicative of the MCS of the fourth message.

In a twentieth aspect, alone or in combination with one or more of the first through nineteenth aspects, process 700 includes determining whether to interpret the MCS index based at least in part on a first MCS table or a second MCS table, wherein interpreting the MCS index is based at least in part on determining to interpret the MCS index based at least in part on the second MCS table.

In a twenty-first aspect, alone or in combination with one or more of the first through twentieth aspects, process 700 includes receiving signaling from the network node configuring the second MCS table.

In a twenty-second aspect, alone or in combination with one or more of the first through twenty-first aspects, the MCS index is not indicative of an MCS of the RACH transmission.

In a twenty-third aspect, alone or in combination with one or more of the first through twenty-second aspects, performing the decode operation includes decoding the fourth message.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, at a UE or an apparatus of a UE. Example process 800 is an example where the apparatus or the UE (e.g., UE 120) performs operations associated with repetitions of RACH transmissions.

As shown in FIG. 8, in some aspects, process 800 may include receiving, from a network node, signaling indicating that the network node supports UE-specific repetitions for a second message of a two-step RACH procedure (block 810). For example, the UE (e.g., using reception component 1002 or communication manager 1006, depicted in FIG. 10) may receive, from a network node, signaling indicating that the network node supports UE-specific repetitions for a second message of a two-step RACH procedure, as described above.

As further shown in FIG. 8, in some aspects, process 800 may include receiving, from the network node, DCI scheduling the second message, wherein the DCI comprises an indication of a quantity of repetitions for the second message that is specific to the UE (block 820). For example, the UE (e.g., using reception component 1002 or communication manager 1006, depicted in FIG. 10) may receive, from the network node, DCI scheduling the second message, wherein the DCI comprises an indication of a quantity of repetitions for the second message that is specific to the UE, as described above.

As further shown in FIG. 8, in some aspects, process 800 may include performing a decode operation for the second message of the two-step RACH procedure based at least in part on monitoring for the quantity of repetitions of the second message (block 830). For example, the UE (e.g., using communication manager 1006, depicted in FIG. 10) may perform a decode operation for the second message of the two-step RACH procedure based at least in part on monitoring for the quantity of repetitions of the second message, as described above.

Process 800 may include additional aspects, such as any single aspect or any combination of aspects described below or in connection with one or more other processes described elsewhere herein.

In a first aspect, process 800 includes transmitting, to the network node, UE capability information indicating that the UE supports the UE-specific repetitions for the second message, wherein the DCI comprises the indication of the quantity of repetitions based at least in part on the UE supporting the UE-specific repetitions for the second message.

In a second aspect, alone or in combination with the first aspect, the UE capability information is within a first message of the two-step RACH procedure.

In a third aspect, alone or in combination with one or more of the first and second aspects, transmitting the UE capability information is based at least in part on transmitting a PRACH sequence that is indicative of the UE capability information.

In a fourth aspect, alone or in combination with one or more of the first through third aspects, process 800 includes transmitting, to the network node, a request for the UE-specific repetitions for the second message, wherein the DCI comprises the indication of the quantity of repetitions based at least in part on the request.

In a fifth aspect, alone or in combination with one or more of the first through fourth aspects, the request further comprises a requested quantity of the repetitions for the second message.

In a sixth aspect, alone or in combination with one or more of the first through fifth aspects, the request is within a first message of the two-step RACH procedure.

In a seventh aspect, alone or in combination with one or more of the first through sixth aspects, transmitting the request is based at least in part on transmitting a PRACH sequence that is indicative of the request.

In an eighth aspect, alone or in combination with one or more of the first through seventh aspects, the indication of the quantity of repetitions for the second message is within a field of the DCI that is not dedicated to the indication of the quantity of repetitions for the second message, and process 800 includes interpreting the field as comprising the indication of the quantity of repetitions based at least in part on receiving the signaling indicating that the network node supports UE-specific repetitions for the second message.

In a ninth aspect, alone or in combination with one or more of the first through eighth aspects, process 800 includes transmitting, to the network node, signaling indicating that the UE supports the UE-specific repetitions for the second message or requesting the UE-specific repetitions for the second message, wherein interpreting the field as comprising the indication of the quantity of repetitions is based at least in part on the transmitting.

In a tenth aspect, alone or in combination with one or more of the first through ninth aspects, a TDRA within the DCI comprises the indication of the quantity of repetitions for the second message, and process 800 includes interpreting the TDRA as comprising the indication of the quantity of repetitions for the second message based at least in part on receiving the signaling indicating that the network node supports UE-specific repetitions for the second message.

In an eleventh aspect, alone or in combination with one or more of the first through tenth aspects, the TDRA indicates a row within a TDRA table that is indicative of the quantity of repetitions for the second message.

In a twelfth aspect, alone or in combination with one or more of the first through eleventh aspects, the row within the TDRA table that is indicative of the quantity of repetitions for the second message is not indicative of the TDRA for the second message, and process 800 includes identifying that the TDRA for the second message corresponds to a default TDRA based at least in part on the row within the TDRA table not being indicative of the TDRA for the second message.

In a thirteenth aspect, alone or in combination with one or more of the first through twelfth aspects, the row within the TDRA table is further indicative of the TDRA for the second message.

In a fourteenth aspect, alone or in combination with one or more of the first through thirteenth aspects, process 800 includes determining whether to interpret the TDRA based at least in part on a first TDRA table or a second TDRA table, wherein interpreting the TDRA is based at least in part on determining to interpret the TDRA based on the second TDRA table.

In a fifteenth aspect, alone or in combination with one or more of the first through fourteenth aspects, process 800 includes receiving signaling from the network node configuring the second TDRA table.

In a sixteenth aspect, alone or in combination with one or more of the first through fifteenth aspects, an MCS index within the DCI comprises the indication of the quantity of repetitions for the second message, and process 800 includes interpreting the MCS index as comprising the indication of the quantity of repetitions for the second message based at least in part on receiving the signaling indicating that the network node supports UE-specific repetitions for the second message.

In a seventeenth aspect, alone or in combination with one or more of the first through sixteenth aspects, one or more bits of the MCS index indicate the quantity of repetitions for the second message, and one or more bits of the MCS index indicate an MCS of the second message.

In an eighteenth aspect, alone or in combination with one or more of the first through seventeenth aspects, the MCS index is not indicative of an MCS of the second message, and process 800 includes identifying that the MCS of the second message corresponds to a default MCS based at least in part on the MCS index not being indicative of the MCS of the second message.

In a nineteenth aspect, alone or in combination with one or more of the first through eighteenth aspects, process 800 includes determining whether to interpret the MCS index based at least in part on a first MCS table or a second MCS table, wherein interpreting the MCS index is based at least in part on determining to interpret the MCS index based at least in part on the second MCS table.

In a twentieth aspect, alone or in combination with one or more of the first through nineteenth aspects, process 800 includes receiving signaling from the network node configuring the second MCS table.

In a twenty-first aspect, alone or in combination with one or more of the first through twentieth aspects, performing the decode operation includes decoding the second message.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, at a network node or an apparatus of a network node. Example process 900 is an example where the apparatus or the network node (e.g., network node 110) performs operations associated with repetitions of RACH transmissions.

As shown in FIG. 9, in some aspects, process 900 may include transmitting, to a UE, signaling indicating that the network node supports UE-specific repetitions for a RACH transmission from the network node during a RACH procedure (block 910). For example, the network node (e.g., using transmission component 1104 or communication manager 1106, depicted in FIG. 11) may transmit, to a UE, signaling indicating that the network node supports UE-specific repetitions for a RACH transmission from the network node during a RACH procedure, as described above.

As further shown in FIG. 9, in some aspects, process 900 may include transmitting, to the UE, DCI scheduling the RACH transmission from the network node, wherein the DCI comprises an indication of a quantity of repetitions for the RACH transmission that is specific to the UE (block 920). For example, the network node (e.g., using transmission component 1104 or communication manager 1106, depicted in FIG. 11) may transmit, to the UE, DCI scheduling the RACH transmission from the network node, wherein the DCI comprises an indication of a quantity of repetitions for the RACH transmission that is specific to the UE, as described above.

As further shown in FIG. 9, in some aspects, process 900 may include transmitting the quantity of repetitions of the RACH transmission to the UE (block 930). For example, the network node (e.g., using transmission component 1104 or communication manager 1106, depicted in FIG. 11) may transmit the quantity of repetitions of the RACH transmission to the UE, as described above.

Process 900 may include additional aspects, such as any single aspect or any combination of aspects described below or in connection with one or more other processes described elsewhere herein.

In a first aspect, the RACH transmission comprises a PDSCH transmission that is transmitted to the UE prior to a completion of a setup of a RRC connection between the UE and network node.

In a second aspect, alone or in combination with the first aspect, process 900 includes receiving, from the UE, UE capability information indicating that the UE supports the UE-specific repetitions for the RACH transmission, wherein the DCI comprises the indication of the quantity of repetitions based at least in part on the UE supporting the UE-specific repetitions for the RACH transmission.

In a third aspect, alone or in combination with one or more of the first and second aspects, receiving the UE capability information comprises receiving the UE capability information within a physical uplink shared channel transmission of the RACH procedure.

In a fourth aspect, alone or in combination with one or more of the first through third aspects, process 900 includes receiving, from the UE, a request for the UE-specific repetitions for the RACH transmission, wherein the DCI comprises the indication of the quantity of repetitions based at least in part on the request.

In a fifth aspect, alone or in combination with one or more of the first through fourth aspects, the request further comprises a requested quantity of the repetitions for the RACH transmission.

In a sixth aspect, alone or in combination with one or more of the first through fifth aspects, receiving the request comprises receiving the request within a physical uplink shared channel transmission of the RACH procedure.

In a seventh aspect, alone or in combination with one or more of the first through sixth aspects, receiving the request is based at least in part on receiving a PRACH sequence that is indicative of the request.

In an eighth aspect, alone or in combination with one or more of the first through seventh aspects, the indication of the quantity of repetitions for the RACH transmission is within a field of the DCI that is not dedicated to the indication of the quantity of repetitions for the RACH transmission.

In a ninth aspect, alone or in combination with one or more of the first through eighth aspects, a TDRA within the DCI comprises the indication of the quantity of repetitions for the RACH transmission.

In a tenth aspect, alone or in combination with one or more of the first through ninth aspects, the TDRA indicates a row within a TDRA table that is indicative of the quantity of repetitions for the RACH transmission.

In an eleventh aspect, alone or in combination with one or more of the first through tenth aspects, the row within the TDRA table that is indicative of the quantity of repetitions for the RACH transmission is not indicative of the TDRA for the RACH transmission.

In a twelfth aspect, alone or in combination with one or more of the first through eleventh aspects, the row within the TDRA table is further indicative of the TDRA for the RACH transmission.

In a thirteenth aspect, alone or in combination with one or more of the first through twelfth aspects, an MCS index within the DCI comprises the indication of the quantity of repetitions for the RACH transmission.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram of an example apparatus 1000 for wireless communication n. The apparatus 1000 may be a UE, or a UE may include the apparatus 1000. In some aspects, the apparatus 1000 includes a reception component 1002, a transmission component 1004, or a communication manager 1006, which may be in communication with one another (for example, via one or more buses or one or more other components). In some aspects, the communication manager 1006 is the communication manager 150 described in connection with FIG. 1. As shown, the apparatus 1000 may communicate with another apparatus 1008, such as a UE or a network node (such as a CU, a DU, an RU, or a base station), using the reception component 1002 and the transmission component 1004. The communication manager 1006 may be included in, or implemented via, a processing system (for example, the processing system 140 described in connection with FIG. 1) of the UE.

In some aspects, the apparatus 1000 may be configured to perform one or more operations described herein in connection with FIGS. 3-5. Additionally, or alternatively, the apparatus 1000 may be configured to perform one or more processes described herein, such as process 600 of FIG. 6, process 700 of FIG. 7, process 800 of FIG. 8, or a combination thereof. In some aspects, the apparatus 1000 or one or more components shown in FIG. 10 may include one or more components of the UE described in connection with FIG. 1. Additionally, or alternatively, one or more components shown in FIG. 10 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1002 may receive communications, such as reference signals, control information, data communications, or a combination thereof, from the apparatus 1008. The reception component 1002 may provide received communications to one or more other components of the apparatus 1000. In some aspects, the reception component 1002 may perform signal processing on the received communications, and may provide the processed signals to the one or more other components of the apparatus 1000. In some aspects, the reception component 1002 may include one or more components of the UE described above in connection with FIG. 1, such as a radio, one or more RF chains, one or more transceivers, or one or more modems, each of which may in turn be coupled with one or more antennas of the UE.

The transmission component 1004 may transmit communications, such as reference signals, control information, data communications, or a combination thereof, to the apparatus 1008. In some aspects, one or more other components of the apparatus 1000 may generate communications and may provide the generated communications to the transmission component 1004 for transmission to the apparatus 1008. In some aspects, the transmission component 1004 may perform signal processing on the generated communications, and may transmit the processed signals to the apparatus 1008. In some aspects, the transmission component 1004 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 1004 may be co-located with the reception component 1002.

The communication manager 1006 may support operations of the reception component 1002 or the transmission component 1004. For example, the communication manager 1006 may receive information associated with configuring reception of communications by the reception component 1002 or transmission of communications by the transmission component 1004. Additionally, or alternatively, the communication manager 1006 may generate or provide control information to the reception component 1002 or the transmission component 1004 to control reception or transmission of communications.

The reception component 1002 may receive, from a network node, signaling indicating that the network node supports UE-specific repetitions for a RACH transmission from the network node during a RACH procedure. The reception component 1002 may receive, from the network node, DCI scheduling the RACH transmission from the network node, wherein the DCI comprises an indication of a quantity of repetitions for the RACH transmission that is specific to the UE. The communication manager 1006 may perform a decode operation for the RACH transmission based at least in part on monitoring for the quantity of repetitions of the RACH transmission.

The transmission component 1004 may transmit, to the network node, UE capability information indicating that the UE supports the UE-specific repetitions for the RACH transmission, wherein the DCI comprises the indication of the quantity of repetitions based at least in part on the UE supporting the UE-specific repetitions for the RACH transmission.

The transmission component 1004 may transmit, to the network node, a request for the UE-specific repetitions for the RACH transmission, wherein the DCI comprises the indication of the quantity of repetitions based at least in part on the request.

The transmission component 1004 may transmit, to the network node, signaling indicating that the UE supports the UE-specific repetitions for the RACH transmission or requesting the UE-specific repetitions for the RACH transmission, wherein interpreting the field as comprising the indication of the quantity of repetitions is based at least in part on the transmitting.

The communication manager 1006 may determine whether to interpret the TDRA based at least in part on a first TDRA table or a second TDRA table, wherein interpreting the TDRA is based at least in part on determining to interpret the TDRA based on the second TDRA table.

The reception component 1002 may receive signaling from the network node configuring the second TDRA table.

The communication manager 1006 may determine whether to interpret the MCS index based at least in part on a first MCS table or a second MCS table, wherein interpreting the MCS index is based at least in part on determining to interpret the MCS index based at least in part on the second MCS table.

The reception component 1002 may receive signaling from the network node configuring the second MCS table.

The reception component 1002 may receive, from a network node, signaling indicating that the network node supports UE-specific repetitions for a fourth message of a four-step RACH procedure. The reception component 1002 may receive, from the network node, DCI scheduling the fourth message, wherein the DCI comprises an indication of a quantity of repetitions for the fourth message that is specific to the UE. The communication manager 1006 may perform a decode operation for the fourth message of the four-step RACH procedure based at least in part on monitoring for the quantity of repetitions of the fourth message.

The transmission component 1004 may transmit, to the network node, UE capability information indicating that the UE supports the UE-specific repetitions for the fourth message, wherein the DCI comprises the indication of the quantity of repetitions based at least in part on the UE supporting the UE-specific repetitions for the fourth message.

The transmission component 1004 may transmit, to the network node, a request for the UE-specific repetitions for the fourth message, wherein the DCI comprises the indication of the quantity of repetitions based at least in part on the request.

The communication manager 1006 may perform a measurement associated with a signal quality of a second message of the four-step RACH procedure, wherein requesting the UE-specific repetitions for the fourth message is based at least in part on the measurement failing to satisfy a threshold.

The transmission component 1004 may transmit, to the network node, signaling indicating that the UE supports the UE-specific repetitions for the fourth message or requesting the UE-specific repetitions for the fourth message, wherein interpreting the field as comprising the indication of the quantity of repetitions is based at least in part on the transmitting.

The reception component 1002 may receive, from a network node, signaling indicating that the network node supports UE-specific repetitions for a second message of a two-step RACH procedure. The reception component 1002 may receive, from the network node, DCI scheduling the second message, wherein the DCI comprises an indication of a quantity of repetitions for the second message that is specific to the UE. The communication manager 1006 may perform a decode operation for the second message of the two-step RACH procedure based at least in part on monitoring for the quantity of repetitions of the second message.

The transmission component 1004 may transmit, to the network node, UE capability information indicating that the UE supports the UE-specific repetitions for the second message, wherein the DCI comprises the indication of the quantity of repetitions based at least in part on the UE supporting the UE-specific repetitions for the second message.

The transmission component 1004 may transmit, to the network node, a request for the UE-specific repetitions for the second message, wherein the DCI comprises the indication of the quantity of repetitions based at least in part on the request.

The transmission component 1004 may transmit, to the network node, signaling indicating that the UE supports the UE-specific repetitions for the second message or requesting the UE-specific repetitions for the second message, wherein interpreting the field as comprising the indication of the quantity of repetitions is based at least in part on the transmitting.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

FIG. 11 is a diagram of an example apparatus 1100 for wireless communication. The apparatus 1100 may be a network node, or a network node may include the apparatus 1100. In some aspects, the apparatus 1100 includes a reception component 1102, a transmission component 1104, or a communication manager 1106, which may be in communication with one another (for example, via one or more buses or one or more other components). In some aspects, the communication manager 1106 is the communication manager 155 described in connection with FIG. 1. As shown, the apparatus 1100 may communicate with another apparatus 1108, such as a UE or a network node (such as a CU, a DU, an RU, or a base station), using the reception component 1102 and the transmission component 1104. The communication manager 1106 may be included in, or implemented via, a processing system (for example, the processing system 145 described in connection with FIG. 1) of the network node.

In some aspects, the apparatus 1100 may be configured to perform one or more operations described herein in connection with FIGS. 3-5. Additionally, or alternatively, the apparatus 1100 may be configured to perform one or more processes described herein, such as process 900 of FIG. 9, or a combination thereof. In some aspects, the apparatus 1100 or one or more components shown in FIG. 11 may include one or more components of the network node described in connection with FIG. 1. Additionally, or alternatively, one or more components shown in FIG. 11 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1102 may receive communications, such as reference signals, control information, data communications, or a combination thereof, from the apparatus 1108. The reception component 1102 may provide received communications to one or more other components of the apparatus 1100. In some aspects, the reception component 1102 may perform signal processing on the received communications, and may provide the processed signals to the one or more other components of the apparatus 1100. In some aspects, the reception component 1102 may include one or more components of the network node described above in connection with FIG. 1, such as a radio, one or more RF chains, one or more transceivers, or one or more modems, each of which may in turn be coupled with one or more antennas of the network node. In some aspects, the reception component 1102 or the transmission component 1104 may include or may be included in a network interface. The network interface may be configured to obtain or output signals for the apparatus 1100 via one or more communications links, such as a backhaul link, a midhaul link, or a fronthaul link.

The transmission component 1104 may transmit communications, such as reference signals, control information, data communications, or a combination thereof, to the apparatus 1108. In some aspects, one or more other components of the apparatus 1100 may generate communications and may provide the generated communications to the transmission component 1104 for transmission to the apparatus 1108. In some aspects, the transmission component 1104 may perform signal processing on the generated communications, and may transmit the processed signals to the apparatus 1108. In some aspects, the transmission component 1104 may include one or more components of the network node described above in connection with FIG. 1, such as a radio, one or more RF chains, one or more transceivers, or one or more modems, each of which may in turn be coupled with one or more antennas of the network node described in connection with FIG. 1. In some aspects, the transmission component 1104 may be co-located with the reception component 1102.

The communication manager 1106 may support operations of the reception component 1102 or the transmission component 1104. For example, the communication manager 1106 may receive information associated with configuring reception of communications by the reception component 1102 or transmission of communications by the transmission component 1104. Additionally, or alternatively, the communication manager 1106 may generate or provide control information to the reception component 1102 or the transmission component 1104 to control reception or transmission of communications.

The transmission component 1104 may transmit, to a UE, signaling indicating that the network node supports UE-specific repetitions for a RACH transmission from the network node during a RACH procedure. The transmission component 1104 may transmit, to the UE, DCI scheduling the RACH transmission from the network node, wherein the DCI comprises an indication of a quantity of repetitions for the RACH transmission that is specific to the UE. The transmission component 1104 may transmit the quantity of repetitions of the RACH transmission to the UE.

The reception component 1102 may receive, from the UE, UE capability information indicating that the UE supports the UE-specific repetitions for the RACH transmission, wherein the DCI comprises the indication of the quantity of repetitions based at least in part on the UE supporting the UE-specific repetitions for the RACH transmission.

The reception component 1102 may receive, from the UE, a request for the UE-specific repetitions for the RACH transmission, wherein the DCI comprises the indication of the quantity of repetitions based at least in part on the request.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

The following provides an overview of some Aspects of the present disclosure:

Aspect 1: A method of wireless communication performed by a UE, comprising: receiving, from a network node, signaling indicating that the network node supports UE-specific repetitions for a RACH transmission from the network node during a RACH procedure; receiving, from the network node, DCI scheduling the RACH transmission from the network node, wherein the DCI comprises an indication of a quantity of repetitions for the RACH transmission that is specific to the UE; and performing a decode operation for the RACH transmission based at least in part on monitoring for the quantity of repetitions of the RACH transmission.

Aspect 2: The method of Aspect 1, wherein the RACH transmission comprises a PDSCH transmission that is received from the network node prior to a completion of a setup of a RRC connection between the UE and network node.

Aspect 3: The method of Aspect 2, wherein: wherein the RACH procedure is a four-step RACH procedure and the PDSCH transmission is a message 4 in the four-step RACH procedure, and wherein the message 4 corresponds to a first message that comprises a contention resolution MAC CE and an RRC setup message or corresponds to a second message that comprises the RRC setup message and does not comprise the contention resolution MAC CE.

Aspect 4: The method of any of Aspect 2, wherein: the RACH procedure is a two-step RACH procedure and the PDSCH transmission is a message B in the two-step RACH procedure, and wherein the message B comprises an RRC setup message

Aspect 5: The method of any of Aspects 1-4, further comprising: transmitting, to the network node, UE capability information indicating that the UE supports the UE-specific repetitions for the RACH transmission, wherein the DCI comprises the indication of the quantity of repetitions based at least in part on the UE supporting the UE-specific repetitions for the RACH transmission.

Aspect 6: The method of Aspect 5, wherein transmitting the UE capability information comprises transmitting the UE capability information within a physical uplink shared channel transmission of the RACH procedure.

Aspect 7: The method of any of Aspects 1-6, further comprising: transmitting, to the network node, a request for the UE-specific repetitions for the RACH transmission, wherein the DCI comprises the indication of the quantity of repetitions based at least in part on the request.

Aspect 8: The method of Aspect 7, wherein the request further comprises a requested quantity of the repetitions for the RACH transmission.

Aspect 9: The method of Aspect 7, wherein transmitting the request comprises transmitting the request within a physical uplink shared channel transmission of the RACH procedure.

Aspect 10: The method of Aspect 7, wherein transmitting the request is based at least in part on transmitting a PRACH sequence that is indicative of the request.

Aspect 11: The method of any of Aspects 1-10, wherein the indication of the quantity of repetitions for the RACH transmission is within a field of the DCI that is not dedicated to the indication of the quantity of repetitions for the RACH transmission, the method further comprising: interpreting the field as comprising the indication of the quantity of repetitions based at least in part on receiving the signaling indicating that the network node supports UE-specific repetitions for the RACH transmission.

Aspect 12: The method of Aspect 11, further comprising: transmitting, to the network node, signaling indicating that the UE supports the UE-specific repetitions for the RACH transmission or requesting the UE-specific repetitions for the RACH transmission, wherein interpreting the field as comprising the indication of the quantity of repetitions is based at least in part on the transmitting.

Aspect 13: The method of any of Aspects 1-12, wherein a TDRA within the DCI comprises the indication of the quantity of repetitions for the RACH transmission, the method further comprising: interpreting the TDRA as comprising the indication of the quantity of repetitions for the RACH transmission based at least in part on receiving the signaling indicating that the network node supports UE-specific repetitions for the RACH transmission.

Aspect 14: The method of Aspect 13, wherein the TDRA indicates a row within a TDRA table that is indicative of the quantity of repetitions for the RACH transmission.

Aspect 15: The method of Aspect 14, wherein the row within the TDRA table that is indicative of the quantity of repetitions for the RACH transmission is not indicative of the TDRA for the RACH transmission, the method further comprising: identifying that the TDRA for the RACH transmission corresponds to a default TDRA based at least in part on the row within the TDRA table not being indicative of the TDRA for the RACH transmission.

Aspect 16: The method of Aspect 14, wherein the row within the TDRA table is further indicative of the TDRA for the RACH transmission.

Aspect 17: The method of Aspect 13, further comprising: determining whether to interpret the TDRA based at least in part on a first TDRA table or a second TDRA table, wherein interpreting the TDRA is based at least in part on determining to interpret the TDRA based on the second TDRA table.

Aspect 18: The method of Aspect 17, further comprising: receiving signaling from the network node configuring the second TDRA table.

Aspect 19: The method of any of Aspects 1-18, wherein an MCS index within the DCI comprises the indication of the quantity of repetitions for the RACH transmission, the method further comprising: interpreting the MCS index as comprising the indication of the quantity of repetitions for the RACH transmission based at least in part on receiving the signaling indicating that the network node supports UE-specific repetitions for the RACH transmission.

Aspect 20: The method of Aspect 19, wherein: one or more bits of the MCS index indicate the quantity of repetitions for the RACH transmission; and one or more bits of the MCS index indicate an MCS of the RACH transmission.

Aspect 21: The method of Aspect 19, wherein the MCS index is not indicative of an MCS of the RACH transmission, the method further comprising: identifying that the MCS of the RACH transmission corresponds to a default MCS based at least in part on the MCS index not being indicative of the MCS of the RACH transmission.

Aspect 22: The method of Aspect 19, further comprising: determining whether to interpret the MCS index based at least in part on a first MCS table or a second MCS table, wherein interpreting the MCS index is based at least in part on determining to interpret the MCS index based at least in part on the second MCS table.

Aspect 23: The method of Aspect 22, further comprising: receiving signaling from the network node configuring the second MCS table.

Aspect 24: A method of wireless communication performed by a UE, comprising: receiving, from a network node, signaling indicating that the network node supports UE-specific repetitions for a fourth message of a four-step RACH procedure; receiving, from the network node, DCI scheduling the fourth message, wherein the DCI comprises an indication of a quantity of repetitions for the fourth message that is specific to the UE; and performing a decode operation for the fourth message of the four-step RACH procedure based at least in part on monitoring for the quantity of repetitions of the fourth message.

Aspect 25: The method of Aspect 24, further comprising: transmitting, to the network node, UE capability information indicating that the UE supports the UE-specific repetitions for the fourth message, wherein the DCI comprises the indication of the quantity of repetitions based at least in part on the UE supporting the UE-specific repetitions for the fourth message.

Aspect 26: The method of Aspect 25, wherein the UE capability information is within a third message of the four-step RACH procedure.

Aspect 27: The method of Aspect 25, wherein transmitting the UE capability information is based at least in part on transmitting a PRACH sequence that is indicative of the UE capability information.

Aspect 28: The method of Aspect 25, further comprising: transmitting, to the network node, a request for the UE-specific repetitions for the fourth message, wherein the DCI comprises the indication of the quantity of repetitions based at least in part on the request.

Aspect 29: The method of Aspect 28, further comprising: performing a measurement associated with a signal quality of a second message of the four-step RACH procedure, wherein requesting the UE-specific repetitions for the fourth message is based at least in part on the measurement failing to satisfy a threshold.

Aspect 30: The method of Aspect 28, wherein the request further comprises a requested quantity of the repetitions for the fourth message.

Aspect 31: The method of Aspect 28, wherein the request is within a third message of the four-step RACH procedure.

Aspect 32: The method of Aspect 28, wherein transmitting the request is based at least in part on transmitting a PRACH sequence that is indicative of the request.

Aspect 33: The method of any of Aspects 24-32, wherein the indication of the quantity of repetitions for the fourth message is within a field of the DCI that is not dedicated to the indication of the quantity of repetitions for the fourth message, the method further comprising: interpreting the field as comprising the indication of the quantity of repetitions based at least in part on receiving the signaling indicating that the network node supports UE-specific repetitions for the fourth message.

Aspect 34: The method of Aspect 33, further comprising: transmitting, to the network node, signaling indicating that the UE supports the UE-specific repetitions for the fourth message or requesting the UE-specific repetitions for the fourth message, wherein interpreting the field as comprising the indication of the quantity of repetitions is based at least in part on the transmitting.

Aspect 35: The method of any of Aspects 24-34, wherein a TDRA within the DCI comprises the indication of the quantity of repetitions for the fourth message, the method further comprising: interpreting the TDRA as comprising the indication of the quantity of repetitions for the fourth message based at least in part on receiving the signaling indicating that the network node supports UE-specific repetitions for the fourth message.

Aspect 36: The method of Aspect 35, wherein the TDRA indicates a row within a TDRA table that is indicative of the quantity of repetitions for the fourth message.

Aspect 37: The method of Aspect 36, wherein the row within the TDRA table that is indicative of the quantity of repetitions for the fourth message is not indicative of the TDRA for the fourth message, the method further comprising: identifying that the TDRA for the fourth message corresponds to a default TDRA based at least in part on the row within the TDRA table not being indicative of the TDRA for the fourth message.

Aspect 38: The method of Aspect 36, wherein the row within the TDRA table is further indicative of the TDRA for the fourth message.

Aspect 39: The method of Aspect 35, further comprising: determining whether to interpret the TDRA based at least in part on a first TDRA table or a second TDRA table, wherein interpreting the TDRA is based at least in part on determining to interpret the TDRA based on the second TDRA table.

Aspect 40: The method of Aspect 39, further comprising: receiving signaling from the network node configuring the second TDRA table.

Aspect 41: The method of any of Aspects 24-40, wherein an MCS index within the DCI comprises the indication of the quantity of repetitions for the fourth message, the method further comprising: interpreting the MCS index as comprising the indication of the quantity of repetitions for the fourth message based at least in part on receiving the signaling indicating that the network node supports UE-specific repetitions for the fourth message.

Aspect 42: The method of Aspect 41, wherein: one or more bits of the MCS index indicate the quantity of repetitions for the fourth message; and one or more bits of the MCS index indicate an MCS of the fourth message.

Aspect 43: The method of Aspect 41, wherein the MCS index is not indicative of an MCS of the fourth message, the method further comprising: identifying that the MCS of the fourth message corresponds to a default MCS based at least in part on the MCS index not being indicative of the MCS of the fourth message.

Aspect 44: The method of Aspect 41, further comprising: determining whether to interpret the MCS index based at least in part on a first MCS table or a second MCS table, wherein interpreting the MCS index is based at least in part on determining to interpret the MCS index based at least in part on the second MCS table.

Aspect 45: The method of Aspect 44, further comprising: receiving signaling from the network node configuring the second MCS table.

Aspect 46: A method of wireless communication performed by a UE, comprising: receiving, from a network node, signaling indicating that the network node supports UE-specific repetitions for a second message of a two-step RACH procedure; receiving, from the network node, DCI scheduling the second message, wherein the DCI comprises an indication of a quantity of repetitions for the second message that is specific to the UE; and performing a decode operation for the second message of the two-step RACH procedure based at least in part on monitoring for the quantity of repetitions of the second message.

Aspect 47: The method of Aspect 46, further comprising: transmitting, to the network node, UE capability information indicating that the UE supports the UE-specific repetitions for the second message, wherein the DCI comprises the indication of the quantity of repetitions based at least in part on the UE supporting the UE-specific repetitions for the second message.

Aspect 48: The method of Aspect 47, wherein the UE capability information is within a first message of the two-step RACH procedure.

Aspect 49: The method of Aspect 47, wherein transmitting the UE capability information is based at least in part on transmitting a PRACH sequence that is indicative of the UE capability information.

Aspect 50: The method of any of Aspects 46-49, further comprising: transmitting, to the network node, a request for the UE-specific repetitions for the second message, wherein the DCI comprises the indication of the quantity of repetitions based at least in part on the request.

Aspect 51: The method of Aspect 50, wherein the request further comprises a requested quantity of the repetitions for the second message.

Aspect 52: The method of Aspect 50, wherein the request is within a first message of the two-step RACH procedure.

Aspect 53: The method of Aspect 50, wherein transmitting the request is based at least in part on transmitting a PRACH sequence that is indicative of the request.

Aspect 54: The method of any of Aspects 46-53, wherein the indication of the quantity of repetitions for the second message is within a field of the DCI that is not dedicated to the indication of the quantity of repetitions for the second message, the method further comprising: interpreting the field as comprising the indication of the quantity of repetitions based at least in part on receiving the signaling indicating that the network node supports UE-specific repetitions for the second message.

Aspect 55: The method of Aspect 54, further comprising: transmitting, to the network node, signaling indicating that the UE supports the UE-specific repetitions for the second message or requesting the UE-specific repetitions for the second message, wherein interpreting the field as comprising the indication of the quantity of repetitions is based at least in part on the transmitting.

Aspect 56: The method of any of Aspects 46-55, wherein a TDRA within the DCI comprises the indication of the quantity of repetitions for the second message, the method further comprising: interpreting the TDRA as comprising the indication of the quantity of repetitions for the second message based at least in part on receiving the signaling indicating that the network node supports UE-specific repetitions for the second message.

Aspect 57: The method of Aspect 56, wherein the TDRA indicates a row within a TDRA table that is indicative of the quantity of repetitions for the second message.

Aspect 58: The method of Aspect 57, wherein the row within the TDRA table that is indicative of the quantity of repetitions for the second message is not indicative of the TDRA for the second message, the method further comprising: identifying that the TDRA for the second message corresponds to a default TDRA based at least in part on the row within the TDRA table not being indicative of the TDRA for the second message.

Aspect 59: The method of Aspect 57, wherein the row within the TDRA table is further indicative of the TDRA for the second message.

Aspect 60: The method of Aspect 56, further comprising: determining whether to interpret the TDRA based at least in part on a first TDRA table or a second TDRA table, wherein interpreting the TDRA is based at least in part on determining to interpret the TDRA based on the second TDRA table.

Aspect 61: The method of Aspect 60, further comprising: receiving signaling from the network node configuring the second TDRA table.

Aspect 62: The method of any of Aspects 46-61, wherein an MCS index within the DCI comprises the indication of the quantity of repetitions for the second message, the method further comprising: interpreting the MCS index as comprising the indication of the quantity of repetitions for the second message based at least in part on receiving the signaling indicating that the network node supports UE-specific repetitions for the second message.

Aspect 63: The method of Aspect 62, wherein: one or more bits of the MCS index indicate the quantity of repetitions for the second message; and one or more bits of the MCS index indicate an MCS of the second message.

Aspect 64: The method of Aspect 62, wherein the MCS index is not indicative of an MCS of the second message, the method further comprising: identifying that the MCS of the second message corresponds to a default MCS based at least in part on the MCS index not being indicative of the MCS of the second message.

Aspect 65: The method of Aspect 63, further comprising: determining whether to interpret the MCS index based at least in part on a first MCS table or a second MCS table, wherein interpreting the MCS index is based at least in part on determining to interpret the MCS index based at least in part on the second MCS table.

Aspect 66: The method of Aspect 65, further comprising: receiving signaling from the network node configuring the second MCS table.

Aspect 67: A method of wireless communication performed by a network node, comprising: transmitting, to a UE, signaling indicating that the network node supports UE-specific repetitions for a RACH transmission from the network node during a RACH procedure; transmitting, to the UE, DCI scheduling the RACH transmission from the network node, wherein the DCI comprises an indication of a quantity of repetitions for the RACH transmission that is specific to the UE; and transmitting the quantity of repetitions of the RACH transmission to the UE.

Aspect 68: The method of Aspect 67, wherein the RACH transmission comprises a PDSCH transmission that is transmitted to the UE prior to a completion of a setup of a RRC connection between the UE and network node.

Aspect 69: The method of any of Aspects 67-68, further comprising: receiving, from the UE, UE capability information indicating that the UE supports the UE-specific repetitions for the RACH transmission, wherein the DCI comprises the indication of the quantity of repetitions based at least in part on the UE supporting the UE-specific repetitions for the RACH transmission.

Aspect 70: The method of Aspect 69, wherein receiving the UE capability information comprises receiving the UE capability information within a physical uplink shared channel transmission of the RACH procedure.

Aspect 71: The method of any of Aspects 67-70, further comprising: receiving, from the UE, a request for the UE-specific repetitions for the RACH transmission, wherein the DCI comprises the indication of the quantity of repetitions based at least in part on the request.

Aspect 72: The method of Aspect 71, wherein the request further comprises a requested quantity of the repetitions for the RACH transmission.

Aspect 73: The method of Aspect 71, wherein receiving the request comprises receiving the request within a physical uplink shared channel transmission of the RACH procedure.

Aspect 74: The method of Aspect 71, wherein receiving the request is based at least in part on receiving a PRACH sequence that is indicative of the request.

Aspect 75: The method of any of Aspects 67-74, wherein the indication of the quantity of repetitions for the RACH transmission is within a field of the DCI that is not dedicated to the indication of the quantity of repetitions for the RACH transmission.

Aspect 76: The method of any of Aspects 67-75, wherein a TDRA within the DCI comprises the indication of the quantity of repetitions for the RACH transmission.

Aspect 77: The method of Aspect 76, wherein the TDRA indicates a row within a TDRA table that is indicative of the quantity of repetitions for the RACH transmission.

Aspect 78: The method of Aspect 77, wherein the row within the TDRA table that is indicative of the quantity of repetitions for the RACH transmission is not indicative of the TDRA for the RACH transmission.

Aspect 79: The method of Aspect 77, wherein the row within the TDRA table is further indicative of the TDRA for the RACH transmission.

Aspect 80: The method of any of Aspects 67-79, wherein an MCS index within the DCI comprises the indication of the quantity of repetitions for the RACH transmission.

Aspect 81: The method of Aspect 80, wherein: one or more bits of the MCS index indicate the quantity of repetitions for the RACH transmission; and one or more bits of the MCS index indicate an MCS of the RACH transmission.

Aspect 82: The method of Aspect 80, wherein the MCS index is not indicative of an MCS of the RACH transmission.

Aspect 83: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-82.

Aspect 84: An apparatus for wireless communication at a device, the apparatus comprising one or more memories and one or more processors coupled to the one or more memories, the one or more processors configured to cause the device to perform the method of one or more of Aspects 1-82.

Aspect 85: An apparatus for wireless communication, the apparatus comprising at least one means for performing the method of one or more of Aspects 1-82.

Aspect 86: A non-transitory computer-readable medium storing code for wireless communication, the code comprising instructions executable by one or more processors to perform the method of one or more of Aspects 1-82.

Aspect 87: A non-transitory computer-readable medium storing a set of instructions for wireless communication, the set of instructions comprising one or more instructions that, when executed by one or more processors of a device, cause the device to perform the method of one or more of Aspects 1-82.

Aspect 88: A device for wireless communication, the device comprising a processing system that includes one or more processors and one or more memories coupled with the one or more processors, the processing system configured to cause the device to perform the method of one or more of Aspects 1-82.

Aspect 89: An apparatus for wireless communication at a device, the apparatus comprising one or more memories and one or more processors coupled to the one or more memories, the one or more processors individually or collectively configured to cause the device to perform the method of one or more of Aspects 1-82.

Aspect 90: A device comprising a processing system that includes one or more processors and one or more code-storing memories coupled with the one or more processors, the processing system configured to cause the device to perform the method of one or more of Aspects 1-82.

Aspect 91: A device comprising a processing system that includes processor circuitry and code-storing memory circuitry, the processing system configured to cause the device to perform the method of one or more of Aspects 1-82.

It will be apparent that systems or methods described herein may be implemented in different forms of hardware or a combination of hardware and software. A component being configured to perform a function means that the component has a capability to perform the function, and does not require the function to be actually performed by the component, unless noted otherwise.

As used herein, the term “determine” or “determining” can encompass one or more of a wide variety of actions. For example, “determining” can include one or more of calculating, computing, processing, deriving, detecting, estimating, investigating, looking up, inferring, ascertaining, measuring, resolving, selecting, choosing, obtaining, identifying, interpreting, demodulating, decoding, reading, establishing, forming or generating, among other examples. In some such examples, determining can involve a processor performing some type of calculating, computing, deriving, estimating, inferring, ascertaining, resolving, predicting or other processing to obtain one or more numerical values, sets, elements or other information or results. In some other such examples, determining can involve a processor identifying, looking up, investigating or otherwise obtaining some type of value, set, element or other information or result from a table, a data structure, a database or other memory device or location. In some other such examples, determining can involve a processor identifying, interpreting, demodulating, decoding, detecting, reading or otherwise obtaining some type of value, set, element or other information or result signaled in, for example, a received wireless packet. In some other such examples, determining can involve a processor selecting or choosing one or more values, sets, elements or other information or results from a larger set of values, sets elements or other information or results. In some other such examples, determining can involve a processor performing a measurement, such as on a received signal.

As used herein, the articles “a” and “an” are intended to refer to one or more items and may be used interchangeably with “one or more” or “at least one.” As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Additionally, as used herein, a “set” can refer to one or more items, and a “subset” can refer to a whole set or less than the whole set, but not an empty set. “Set,” “group,” and similar terms are intended to include one or more items and may be used interchangeably with “one or more.” Furthermore, as used herein, the term “or” is intended to be interpreted in the inclusive sense (such as when referring to a series) and may be used interchangeably with “and/or,” unless otherwise explicitly indicated (for example, if used in conjunction with “either” or “only one of”). For example, “A or B” may include A only, B only, or a combination of A and B. Also, as used herein, the terms “has,” “have,” “having,” “comprise,” “comprising,” “include” and “including,” and derivatives thereof or similar terms are intended to be open-ended terms that do not limit an element that they modify (for example, an element “having” A also may have B).

As used herein, the phrase “associated with” is intended to be interpreted in the inclusive sense, unless otherwise explicitly indicated. For example, the phrase “associated with” is not to be construed as a reference to a closed set of conditions, factors, criteria, elements, components, or actions, among other examples. Specifically, unless a phrase refers to “associated with only ‘a,’” or the equivalent in context, whatever it is that is “associated with ‘a,’” may be associated with “a” alone or associated with a combination of “a” and one or more other conditions, factors, criteria, elements, components, or actions, among other examples. In various examples, the phrase “associated with” may be interpreted to mean “in association with,” “in accordance with,” “based on,” “based at least in part on,” “as a function of,” “in response to,” “responsive to,” or “using” as appropriate in the relevant context unless otherwise explicitly indicated. Furthermore, what follows the phrase “associated with,” “in association with,” “in accordance with,” “based on,” “based at least in part on,” “as a function of,” “in response to,” “responsive to,” or “using” is not necessarily the focal point or primary factor associated with the limitation preceding the phrase.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A user equipment (UE), comprising:
a processing system that includes one or more processors and one or more code-storing memories coupled with the one or more processors, the processing system configured to cause the UE to:
receive, from a network node, signaling indicating that the network node supports UE-specific repetitions for a random access channel (RACH) transmission from the network node during a RACH procedure;
receive, from the network node, downlink control information scheduling the RACH transmission from the network node, wherein the downlink control information comprises an indication of a quantity of repetitions for the RACH transmission that is specific to the UE; and
perform a decode operation for the RACH transmission based at least in part on monitoring for the quantity of repetitions of the RACH transmission.

2. The UE of claim 1, wherein the processing system is configured to cause the UE to:
transmit, to the network node, UE capability information indicating that the UE supports the UE-specific repetitions for the RACH transmission, wherein the downlink control information comprises the indication of the quantity of repetitions based at least in part on the UE supporting the UE-specific repetitions for the RACH transmission.

3. The UE of claim 1, wherein the processing system is configured to cause the UE to:
transmit, to the network node, a request for the UE-specific repetitions for the RACH transmission, wherein the downlink control information comprises the indication of the quantity of repetitions based at least in part on the request.

4. The UE of claim 1, wherein a modulation and coding scheme (MCS) index within the downlink control information comprises the indication of the quantity of repetitions for the RACH transmission.

5. The UE of claim 4, wherein the processing system is configured to cause the UE to:
interpret the MCS index as comprising the indication of the quantity of repetitions for the RACH transmission based at least in part on receiving the signaling indicating that the network node supports UE-specific repetitions for the RACH transmission.

6. The UE of claim 4, wherein:
one or more bits of the MCS index indicate the quantity of repetitions for the RACH transmission; and
one or more bits of the MCS index indicate an MCS of the RACH transmission.

7. The UE of claim 6, wherein the one or more bits of the MCS index indicate the quantity of repetitions are one or more of the most significant bits of the MCS index.

8. The UE of claim 1, wherein the processing system, to cause the UE to perform the decode operation, is configured to cause the UE to:
decode the RACH transmission.

9. A user equipment (UE), comprising:
a processing system that includes one or more processors and one or more code-storing memories coupled with the one or more processors, the processing system configured to cause the UE to:
receive, from a network node, signaling indicating that the network node supports UE-specific repetitions for a fourth message of a four-step random access channel (RACH) procedure;
receive, from the network node, downlink control information scheduling the fourth message, wherein the downlink control information comprises an indication of a quantity of repetitions for the fourth message that is specific to the UE; and
perform a decode operation to decode the fourth message of the four-step RACH procedure based at least in part on monitoring for the quantity of repetitions of the fourth message.

10. The UE of claim 9, wherein the processing system is configured to cause the UE to:
transmit, to the network node, UE capability information indicating that the UE supports the UE-specific repetitions for the fourth message, wherein the downlink control information comprises the indication of the quantity of repetitions based at least in part on the UE supporting the UE-specific repetitions for the fourth message.

11. The UE of claim 9, wherein the processing system is configured to cause the UE to:
transmit, to the network node, a request for the UE-specific repetitions for the fourth message, wherein the downlink control information comprises the indication of the quantity of repetitions based at least in part on the request.

12. The UE of claim 11, wherein the request further comprises a requested quantity of the repetitions for the fourth message.

13. The UE of claim 9, wherein the indication of the quantity of repetitions for the fourth message is within a field of the downlink control information that is not dedicated to the indication of the quantity of repetitions for the fourth message, and wherein the processing system is configured to cause the UE to:
interpret the field as comprising the indication of the quantity of repetitions based at least in part on receiving the signaling indicating that the network node supports UE-specific repetitions for the fourth message.

14. The UE of claim 9, wherein a modulation and coding scheme (MCS) index within the downlink control information comprises the indication of the quantity of repetitions for the fourth message.

15. The UE of claim 14, wherein the processing system is configured to cause the UE to:
interpret the MCS index as comprising the indication of the quantity of repetitions for the fourth message based at least in part on receiving the signaling indicating that the network node supports UE-specific repetitions for the fourth message.

16. The UE of claim 14, wherein one or more most significant bits of the MCS index indicate the quantity of repetitions for the fourth message.

17. A network node, comprising:
a processing system that includes one or more processors and one or more code-storing memories coupled with the one or more processors, the processing system configured to cause the network node to:
transmit, for a user equipment (UE), signaling indicating that the network node supports UE-specific repetitions for a random access channel (RACH) transmission from the network node during a RACH procedure;
transmit, for the UE, DCI scheduling the RACH transmission from the network node, wherein the DCI comprises a modulation and coding scheme index (MCS), and wherein the MCS index comprises an indication of a quantity of repetitions for the RACH transmission that is specific to the UE; and
transmit the quantity of repetitions of the RACH transmission for the UE.

18. The network node of claim 17, wherein the processing system is configured to cause the network node to:
receive UE capability information indicating that the UE supports the UE-specific repetitions for the RACH transmission, wherein the MCS index comprises the indication of the quantity of repetitions based at least in part on the UE supporting the UE-specific repetitions for the RACH transmission.

19. The network node of claim 18, wherein the UE capability information is within a third message of a four-step RACH procedure.

20. The network node of claim 17, wherein the processing system is configured to cause the network node to:
receive a request for the UE-specific repetitions for the RACH transmission, wherein the MCS index comprises the indication of the quantity of repetitions based at least in part on the request.
